(19) United States
(12) Patent Application Publication
(10) Pub. No.: US 2024/0029504 A1
(43) Pub. Date: Jan. 25, 2024

(54) MULTIPLE PLAYER WAGERING GAME SYSTEMS AND METHODS WITH PLAYER ACTION RANDOMNESS

(71) Applicant: Sak Mahasuverachai, Bangkok (TH)

(72) Inventor: Sak Mahasuverachai, Bangkok (TH)

(21) Appl. No.: 18/225,964

(22) Filed: Jul. 25, 2023

Related U.S. Application Data
(63) Continuation of application No. 17/939,130, filed on Sep. 7, 2022, now abandoned.
Application No. 17/939,130 is a continuation of application No. 17/326,001, filed on May 20, 2021, now abandoned.
Application No. 17/326,001 is a continuation of application No. 16/920,352, filed on Jul. 2, 2020, now abandoned.
Application No. 16/920,352 is a continuation of application No. 15/550,362, filed on Aug. 10, 2017, now abandoned.
(60) Provisional application No. 62/115,796, filed on Feb. 13, 2015.

(51) Int. Cl. G07F 17/32; G07F 17/34

(52) U.S. Cl. CPC G07F 17/3225; G07F 17/3244; G07F 17/323; G07F 17/3241; G07F 17/329; G07F 17/3293; G07F 17/3269; G07F 17/3276; G07F 17/34; G07F 17/3288; G07F 17/3218; G07F 17/3258; G07F 17/3213; G07F 17/3267

(57) ABSTRACT

The present disclosure provides a wagering game platform that employs individual player actions of players within a multiple-player (e.g., massively player) connected wagering game system as the primary and/or sole source of uncertainty within a wagering game. Only collective playing actions (e.g., act of betting and/or wager amount) of the players serve as the basis for the payout outcome such that the wagering game platform does not rely on a random and pseudorandom number generators within the wagering game.

### RELATED APPLICATIONS

The present application claims priority to and the benefit of U.S. Application No. 62/115,796, titled “Multiple Player Wagering Game Systems and Methods With Player Action Randomness,” filed on Feb. 13, 2015, which is hereby incorporated by reference in its entirety.

### BACKGROUND

Wagering games and systems rely on uncertainties as a basis to determine the winning and payout outcomes of a given game. A typical casino wagering system or online gambling system employs an electronic random or pseudorandom process to allow payers to wager on uncertain events determined from such processes. Examples of casino wagering systems include slot machines, video poker machines, video bingo machines, bingo, keno, pachinko, among others.

Even though casino wagering games, as well as online gambling systems, can be audited and tested, the processes of the random and pseudorandom number generators are often unknown to the players. This lack of transparency opens avenues for cheating as well as creates doubt as to the fairness of the game.

In addition to the non-transparent aspect of the random and pseudorandom number generators, they are also not perfect in generating a truly random number. Consequently, such processes are subject to manipulation and circumvention. Accordingly, there is a need for wagering game systems that provide improved transparency and continued gameplay.

### SUMMARY

In general overview, the present disclosure provides a wagering game platform that employs the individual player actions of players within a massively-connected wagering game system as the primary and/or sole source of uncertainty within a wagering game. To this end, only the collective playing actions (e.g., act of betting and/or wager amount) of the players serve as the basis for the payout outcome (namely, those who shall win and how much they will win) and/or the game outcome (i.e., condition that resets and/or end the current game session). The wagering game system records the player actions in real-time, but never present to a given player the individual real-time action of the other players in the same game session. Put another way, individual player actions of players participating in the game are kept hidden from all the other players during the game. In some implementations, the game actions that led to the payout outcome are disclosed (e.g., in tables or graphs) to the players at the conclusion of each game session, advantageously giving the players the opportunity to audit the game. Consequently, in such implementations, the uncertainty employed in the game is no longer a “black-box.”

This technology beneficially enables a new wagering paradigm that can be used in new types of games. The new games can serve as alternatives to existing online and casino games and also provide new and/or different appeal for new groups of players. Remarkably, the technology demonstrates that an electronic wagering game platform does not need to rely on random and pseudorandom number generators as a basis to determine a payout outcome within the game.

The wagering game system provides several elegant incentives for newcomer players and experienced players to adopt the new wagering game and to continue playing the game. For instance, the wagering game is configured to produce a sense of thrill for the player with each wager that is placed. Indeed, since each action of the player changes the aggregated actions received by the game system—it potentially affects the outcome of the game for both himself/herself and for all the participating players. In addition, the system allows for a higher winning outcome for a given wager as compared to other wagering games.

Furthermore, the wagering game allows players of all experience levels to play with one another, beneficially allowing the game to have wide spread appeal. The game rules are straightforward to learn, allowing newcomer players to join. Moreover, although straightforward to learn, the resulting game dynamics are such that they can be studied to improve the frequency of winning on a temporary basis. Players can, for example, develop strategies from observable player patterns, which, in turn, may improve the frequency of winning. As such, a player can be rewarded for investing time in the study and practice of the game, creating incentives to continue to play. However, for the same reasons that the game dynamics can be studied to improve the frequency of winning, the game automatically adapts over time to such strategies as other players would observe the application of certain strategies during game play. Such dynamics ensure that the game is continually adapting and evolving to ensure a fair outcome for all the players.

As indicated above, the wagering game platform presents, in some implementations, at the conclusion of each game, the game actions of the player that led to the payout outcome. The game actions may be presented in tables, graphs, or the like. Indeed, in some embodiments, such data are downloadable by the players, for example, for the purpose of auditing the game, or for the purpose of studying the game.

The wagering game platform is structured such that the operator of the game always receives a revenue stream for each game session. In addition, the game platform also provides a higher payout rate as compared to traditional casino games. In some implementations, the expected payout rate (e.g., a ratio of the chance of a payout to and the amount of the payout) is configured to be better than or comparable to traditional wagering games.

A remarkable number of classes of wagering games can be employed using uncertainties derived from the playing actions of a large number of players within a massively-connected wagering system.

A first example class of games (e.g., “Black and White”, to be later discussed) provides wagerable options in the game for the player to place wagers. Players, in turn, can place wagers to a given wagerable option during a pre-defined game session (i.e., fixed game time, e.g., 5 minutes, 10 minutes, 15 minutes, 30 minutes, 1 hour, etc.). The system aggregates (e.g., in an arithmetic manner) the total amount of wagers placed to a given wagerable option. In turn, the total amount is used to determine the outcome. Specifically, the game establishes, in some implementations, the wagerable option with the non-highest quantity value as a payout condition, thereby beneficially ensuring that the game do not payout more than the wagers received. The wager times and/or wager amounts placed by the players, or the like (e.g., associated with all or substantial portion of the actions of players in the massively multiplayer game), serve as random events for the game. Indeed, the game may have multiple winners. In addition, a player's repeated wager to the winning wagerable option results in a greater payout. In some implementations, the system further allows

players to purchase certain information, during game play, (e.g., which game piece is currently winning) to enhance the game play.

A second example class of game (“Hi-lo”, to be later discussed) provides a large number of wagerable options (e.g., greater than 100s, such as based on the wagers placed by the players). The game employs the repetition of wagers as a basis for determining the payout condition. That is, the system determines a histogram, or the like, of the wagers, and winners are determined based on pre-defined game-rule payout condition of the games (e.g., placement within the histogram, such as the highest-wager least-repetition wagerable option, the second highest-wager least-repetition wagerable option, the third highest-wager least-repetition wagerable option, the lowest-wager least-repetition wagerable option, the second lowest-wager least-repetition wagerable option, the third lowest-wager least-repetition wagerable options, the median-wager least-repetition wagerable option, etc.) The wager amounts (e.g., associated with all or substantial portion of the players in the massively multiplayer game) serve as random events for the game.

A third example class of games (e.g., “Magic 9”, “Devil 6”, to be discussed later) provides a single counter that is incrementable (e.g., in a positive or negative manner) based on wagers placed by the players. The game does not employ a fixed game time. Rather, when the counter is incremented to a pre-defined payout value, the system provides a payout to the player of that last wager that caused that condition to be fulfilled. The wager times and/or wager amounts placed by the players, or the like (e.g., associated with all or substantial portion of the actions of the players in the massively multiplayer game), serve as random events for the game. In some embodiments, the payout occurs when the counter equals the pre-defined payout value (e.g., in “Magic 9”). In other embodiments, the payout occurs when the counter exceeds or equals the pre-defined payout value (e.g., in “Devil 6”). Indeed, the counter resets to an initial value, or the like, (or rolls over, like a circular buffer) when the payout condition is met.

A fourth example class of games (e.g., “RGB”) determines a sequence of wagers placed by the players. The wagers are associated to a wagerable option (e.g., colors, numbers, symbols, or the like), and the system determines a payout condition based on pre-defined patterns in the sequence. Indeed, the selection of the wagerable options by the players and the wager time (e.g., associated with all or a substantial portion of the players in the massively multiplayer game) serve as random events for the game.

A fifth example class of games (e.g., “Lotto” and “slot machine”) employs the player actions as a random number generator for traditional casino game (e.g., slot machines) and lotto games. The wager times and/or wager amounts placed by the player (e.g., associated with all or a substantial portion of the players in the massively multiplayer game) serves as random events for the game.

Further classes of game will become apparent throughout the disclosures herein. In one aspect, the present disclosure describes a method for operating a wagering game system. The method includes receiving, by a processor of a first computing device (e.g. a server), from a plurality of wagering game clients, a plurality of game submissions.

Each player submission, in some implementations, is a data stream, data message, or information packet corresponds to a given player action received at a given wagering game client. Collectively, the player submissions are employed as a basis to determine a payout outcome for players participating in a multiple player (e.g., massively multiplayer) wagering game of the wagering game system (e.g., as opposed to a random or pseudorandom number). Moreover, the individual player actions of players within the wagering game are hidden and/or delayed in presentation to the players.

The method includes, for each of the received player submissions, determining, by the processor, if a given player submission specific to a first player matches a payout condition of the wagering game, where the payout condition is based, at least, on a plurality of player submissions antedating the given player submission. The method includes assigning, by the processor, a game player token associated with a payout to the first player upon a determination that the player submission matches the payout condition. The method includes causing, based on the assigned game player token, a payout indicator to be graphically presented at a wagering game client associated with the first player.

In some embodiments, the payout indicator is graphically displayed at the wagering game client either (i) following a pre-defined time window (i.e., not near real-time) or (ii) following conclusion of the wagering game. In some embodiments, the method further includes causing, by the processor, near real-time graphical presentation (e.g., within 1 second of a player action) of the aggregated wager amount to the wagering game client associated with the first player following receipt of the given player submission specific to the first player.

In some embodiments (e.g., “Black & White”; simple lottery; simple roulette), the step of determining if the given player submission matches the payout condition includes determining if the given player submission is associated with a game token determined to have a lowest aggregated wagering amount from among two or more game tokens available for selection by the player. The aggregated wager amount for each game token is arithmetically determined (e.g., using an addition, subtraction, increment, or decrement operation) based on the given player submission and a plurality of players submissions (a) associated with the game token and (b) antedating the given player submission.

In some embodiments (e.g., “reversed lottery” and “reversed roulette”), the step of determining if the given player submission specific to the first player matches the payout condition includes determining if the given player submission specific to the first player is associated with a game token determined to have a non-highest aggregated wagering amount from among two or more game tokens available for selection by the player. The aggregated wager amount for each game token is arithmetically determined (e.g., using an addition, subtraction, increment, or decrement operation) based on the given player submission and the plurality of players submissions (a) associated with the game token and (b) antedating the given player submission.

In some embodiments (e.g., for “Hi-Lo”), the step of determining if the given player submission specific to the first player matches the payout condition includes determining if the given player submission is associated with a game token determined to be a lowest-wager least-repetition game token from among two or more selectable game tokens available for selection by the first player. The lowest-wager least-repetition game token is determined (e.g., using an addition, subtraction, increment, or decrement operation) based on the given game submission and a plurality of players submissions (a) associated with the game token and (b) antedating the given player submission.

In some embodiments (e.g., for “Hi-Lo”), the step of determining if the given player submission specific to the first player matches the payout condition includes determining if the given player submission is associated with a game token determined to be a highest wager least-repetition game token from among two or more selectable game tokens available for selection by the first player. The highest-wager least-repetition game token is determined (e.g., using an addition, subtraction, increment, or decrement operation) based on the given player submission and a plurality of players submissions (a) associated with the game token and (b) antedating the given player submission.

In some embodiments (e.g., “Magic 9; Devil 6; simple constant payout slot”), the step of determining if the given player submission specific to the first player matches the payout condition includes determining if the given player submission is associated with a wager amount that causes an aggregated wager amount to meet or exceed a payout threshold amount. The aggregated wager amount is arithmetically determined from (i) the wager amount associated with the given player submission and (ii) wager amounts associated with a portion of the plurality of player submissions antedating the given player submission.

In some embodiments (e.g., for “Higher dimension slot”), the step of determining if the given player submission specific to the first player matches the payout condition includes determining if the given player submission produces a pre-defined requisite number of payout game tokens within a set of payout game tokens. Each payout game token of the set of payout game tokens is arithmetically generated, at least, from (i) a wager amount associated with the current player submission and (ii) historic set of payout game tokens generated from a second player submission associated a second player different from the first player. In some embodiments, the second player submission is associated with a game session that concluded immediately preceding the current game session.

In some embodiments, the wagering game client associated with current player submission graphically presents each game token produced from the current player submission as a game symbol on a spinning reel having a plurality of game symbols (e.g., resembling a slot machine).

In some embodiments (e.g., “RGB”), the step of determining if the given player submission specific to the first player matches the payout condition includes determining if the given player submission specific to the first player includes a first game token identifier matching a second game token identifier associated with a second player submission submitted by a second player. The first player submission and the second player submission are defined in respective locations within a queue of the player submissions, the queue being ordered in accordance with a submission sequence of player submission.

In some embodiments, the method includes, responsive to the determination of the matched payout condition, causing, by the processor of the first computing device, an electronic payout to be transferred to a player account associated with the first player. In some embodiments, the method includes, responsive to the determination of the matched payout condition, causing, by the processor of the first computing device, a payout pot (e.g., coins or tokens) to be dispensed at the first wagering game client. In some embodiments, the first wagering game client includes a slot machine or a video gaming machine.

In some embodiments, the first wagering game client includes a computing device associated with a user (e.g., a desktop, laptop, tablet, or mobile device). In some embodiments, the step of updating the game data is based upon the first player submission synchronized to a clock pulse associated with the first computing device. In some embodiments, the given player submission specific to the first player is synchronized to a clock pulse associated with the first computing device.

In some embodiments, the selectable game tokens include binary gameplay symbols that are, for example, distinguishable by color, number, letters, geographic location, people's name, shapes, etc. In some embodiments, the selectable game tokens include a set of themed symbols, for example, card symbols, die symbols; fruit symbols, sport's team symbols, trademarks, etc.

In another aspect, the present disclosure describes a system for operating a wagering game system. The system includes a processor and a memory having instructions thereon, wherein the instructions, when executed by the processor, cause the processor to receive, from a plurality of wagering game clients, a plurality of game submissions. Each player submission corresponds to a given player action received at a given wagering game client. Collectively, the player submissions are employed as a basis to determine a payout outcome for players participating in a multiple player (e.g., massively multiplayer) wagering game of the wagering game system (e.g., as opposed to a random or pseudorandom number). Moreover, the individual player actions of players within the wagering game are hidden and/or delayed in presentation to the players.

The instructions, when executed, further cause the processor to, for each of the received player submissions, determine, if a given player submission specific to a first player matches a payout condition of the wagering game, where the payout condition is based, at least, on player submissions antedating the given player submission. The instructions, when executed, further cause the processor to assign a game player token associated with a payout to the first player upon a determination that the player submission matches the payout condition. The instructions, when executed, further cause the processor to cause, based on the assigned game player token, a payout indicator to be graphically presented at a wagering game client associated with the first player.

In some embodiments (e.g., “Black & White”; simple lottery; simple roulette), the step of determining if the given player submission matches the payout condition includes determining if the given player submission is associated with a game token determined to have a lowest aggregated wagering amount from among two or more game tokens available for selection by the player. The aggregated wager amount for each game token is arithmetically determined (e.g., using an addition, subtraction, increment, or decrement operation) based on the given player submission and a plurality of players submissions (a) associated with the game token and (b) antedating the given player submission.

In some embodiments (e.g., “reversed lottery” and “reversed roulette”), the step of determining if the given player submission specific to the first player matches the payout condition includes determining if the given player submission specific to the first player is associated with a game token determined to have a non-highest aggregated wagering amount from among two or more game tokens available for selection by the player. The aggregated wager amount for each game token is arithmetically determined (e.g., using an addition, subtraction, increment, or decrement operation) based on the given player submission and the plurality of players submissions (a) associated with the game token and (b) antedating the given player submission.

In some embodiments (e.g., for “Hi-Lo”), the step of determining if the given player submission specific to the first player matches the payout condition includes determining if the given player submission is associated with a game token determined to be a lowest-wager least-repetition game token from among two or more selectable game tokens available for selection by the first player. The lowest-wager least-repetition game token is determined (e.g., using an addition, subtraction, increment, or decrement operation) based on the given game submission and a plurality of players submissions (a) associated with the game token and (b) antedating the given player submission.

In some embodiments (e.g., for “Hi-Lo”), the step of determining if the given player submission specific to the first player matches the payout condition includes determining if the given player submission is associated with a game token determined to be a highest wager least-repetition game token from among two or more selectable game tokens available for selection by the first player. The highest-wager least-repetition game token is determined (e.g., using an addition, subtraction, increment, or decrement operation) based on the given player submission and a plurality of players submissions (a) associated with the game token and (b) antedating the given player submission.

In some embodiments (e.g., “Magic 9; Devil 6; simple constant payout slot”), the step of determining if the given player submission specific to the first player matches the payout condition includes determining if the given player submission is associated with a wager amount that causes an aggregated wager amount to meet or exceed a payout threshold amount. The aggregated wager amount is arithmetically determined from (i) the wager amount associated with the given player submission and (ii) wager amounts associated with a portion of the plurality of player submissions antedating the given player submission.

In some embodiments (e.g., for “Higher dimension slot”), the step of determining if the given player submission specific to the first player matches the payout condition includes determining if the given player submission produces a pre-defined requisite number of payout game tokens within a set of payout game tokens. Each payout game token of the set of payout game tokens is arithmetically generated, at least, from (i) a wager amount associated with the current player submission and (ii) historic set of payout game tokens generated from a second player submission associated a second player different from the first player. In some embodiments, the second player submission is associated with a game session that concluded immediately preceding the current game session.

In some embodiments, the wagering game client associated with current player submission graphically presents each game token produced from the current player submission as a game symbol on a spinning reel having a plurality of game symbols (e.g., resembling a slot machine).

In some embodiments (e.g., “RGB”), the step of determining if the given player submission specific to the first player matches the payout condition includes determining if the given player submission specific to the first player includes a first game token identifier matching a second game token identifier associated with a second player submission submitted by a second player. The first player submission and the second player submission are defined in respective locations within a queue of the player submissions, the queue being ordered in accordance with a submission sequence of player submission.

In some embodiments, the instructions, when executed by the processor, cause the processor to, responsive to the determination of the matched payout condition, cause an electronic payout to be transferred to a player account associated with the first player. In some embodiments, the instructions, when executed by the processor, cause the processor to, responsive to the determination of the matched payout condition, cause a payout pot (e.g., coins or tokens) to be dispensed at the first wagering game client. In some embodiments, the first wagering game client includes a slot machine or a video gaming machine. In some embodiments, the first wagering game client includes a computing device associated with a user (e.g., a desktop, laptop, tablet, or mobile device). In some embodiments, the given player submission specific to the first player is synchronized to a clock pulse associated with the first computing device.

In some embodiments, the selectable game tokens include binary gameplay symbols that are, for example, distinguishable by color, number, letters, geographic location, people's name, shapes, etc. In some embodiments, the selectable game tokens include a set themed symbols, for example, card symbols, die symbols; fruit symbols, sport's team symbols, trademarks, etc.

In another aspect, the present disclosure describes a non-transitory computer-readable medium having instructions thereon, wherein the instructions, when executed by the processor, cause the processor to receive, from a plurality of wagering game clients, a plurality of game submissions. Each player submission corresponds to a given player action received at a given wagering game client. Collectively, the player submissions are employed as a basis to determine a payout outcome for players participating in a multiple player (e.g., massively multiplayer) wagering game of the wagering game system (e.g., as opposed to a random or pseudorandom number). Moreover, the individual player actions of players within the wagering game are hidden and/or delayed in presentation to the players.

The instructions, when executed, further cause the processor to, for each of the received player submissions, determine, if a given player submission specific to a first player matches a payout condition of the wagering game, where the payout condition is based, at least, on player submissions antedating the given player submission. The instructions, when executed, further cause the processor to assign a game player token associated with a payout to the first player upon a determination that the player submission matches the payout condition. The instructions, when executed, further cause the processor to cause, based on the assigned game player token, a payout indicator to be graphically presented at a wagering game client associated with the first player.

In some embodiments (e.g., “Black & White”; simple lottery; simple roulette), the step of determining if the given player submission matches the payout condition includes determining if the given player submission is associated with a game token determined to have a lowest aggregated wagering amount from among two or more game tokens available for selection by the player. The aggregated wager amount for each game token is arithmetically determined (e.g., using an addition, subtraction, increment, or decrement operation) based on the given player submission and a plurality of players submissions (a) associated with the game token and (b) antedating the given player submission.

In some embodiments (e.g., “reversed lottery” and “reversed roulette”), the step of determining if the given player submission specific to the first player matches the payout condition includes determining if the given player submission specific to the first player is associated with a game token determined to have a non-highest aggregated wagering amount from among two or more game tokens available for selection by the player. The aggregated wager amount for each game token is arithmetically determined (e.g., using an addition, subtraction, increment, or decrement operation) based on the given player submission and the plurality of players submissions (a) associated with the game token and (b) antedating the given player submission.

In some embodiments (e.g., for “Hi-Lo”), the step of determining if the given player submission specific to the first player matches the payout condition includes determining if the given player submission is associated with a game token determined to be a lowest-wager least-repetition game token from among two or more selectable game tokens available for selection by the first player. The lowest-wager least-repetition game token is determined (e.g., using an addition, subtraction, increment, or decrement operation) based on the given game submission and a plurality of players submissions (a) associated with the game token and (b) antedating the given player submission.

In some embodiments (e.g., for “Hi-Lo”), the step of determining if the given player submission specific to the first player matches the payout condition includes determining if the given player submission is associated with a game token determined to be a highest wager least-repetition game token from among two or more selectable game tokens available for selection by the first player. The highest-wager least-repetition game token is determined (e.g., using an addition, subtraction, increment, or decrement operation) based on the given player submission and a plurality of players submissions (a) associated with the game token and (b) antedating the given player submission.

In some embodiments (e.g., “Magic 9; Devil 6; simple constant payout slot”), the step of determining if the given player submission specific to the first player matches the payout condition includes determining if the given player submission is associated with a wager amount that causes an aggregated wager amount to meet or exceed a payout threshold amount. The aggregated wager amount is arithmetically determined from (i) the wager amount associated with the given player submission and (ii) the wager amount associated with a portion of the plurality of player submissions antedating the given player submission.

In some embodiments (e.g., for “Higher dimension slot”), the step of determining if the given player submission specific to the first player matches the payout condition includes determining if the given player submission produces a pre-defined requisite number of payout game tokens within a set of payout game tokens. Each payout game token of the set of payout game tokens is arithmetically generated, at least, from (i) a wager amount associated with the current player submission and (ii) historic set of payout game tokens generated from a second player submission associated a second player different from the first player. In some embodiments, the second player submission is associated with a game session that concluded immediately preceding the current game session.

In some embodiments, the wagering game client associated with current player submission graphically presents each game token produced from the current player submission as a game symbol on a spinning reel having a plurality of game symbols (e.g., resembling a slot machine).

In some embodiments (e.g., “RGB”), the step of determining if the given player submission specific to the first player matches the payout condition includes determining if the given player submission specific to the first player includes a first game token identifier matching a second game token identifier associated with a second player submission submitted by a second player. The first player submission and the second player submission are defined in respective locations within a queue of the player submissions, the queue being ordered in accordance with a submission sequence of player submission.

In some embodiments, the instructions, when executed by the processor, cause the processor to, responsive to the determination of the matched payout condition, cause an electronic payout to be transferred to a player account associated with the first player. In some embodiments, the instructions, when executed by the processor, cause the processor to, responsive to the determination of the matched payout condition, cause a payout pot (e.g., coins or tokens) to be dispensed at the first wagering game client. In some embodiments, the first wagering game client includes a slot machine or a video gaming machine. In some embodiments, the first wagering game client includes a computing device associated with a user (e.g., a desktop, laptop, tablet, or mobile device). In some embodiments, the given player submission specific to the first player is synchronized to a clock pulse associated with the first computing device.

In some embodiments, the selectable game tokens include binary gameplay symbols that are, for example, distinguishable by color, number, letters, geographic location, people's name, shapes, etc. In some embodiments, the selectable game tokens include a set of themed symbols, for example, card symbols, die symbols; fruit symbols, sport's team symbols, trademarks, etc.

In another aspect, the present disclosure describes a method for operating a wagering game client of a wagering game system. The method includes receiving, at the wagering game client, a player input associated with a user interface of the first wagering game client. The method includes transmitting, over a network, to a central processing computing device associated with the wagering game, a player submission. The player submission includes an identifier of the wagering game client and the player input and is synchronized to a clock pulse associated with the first computing device to determine a player token. The player token (e.g., a card, die, or a gameplay piece) is employed as a basis for the determination of an outcome of the wagering game for all the players participating in the wagering game (as opposed to a random or pseudorandom number). In some embodiments, the player submission includes an identifier of the player (e.g. a credit card number or a player identification number). The individual player actions of players within the wagering game are hidden and/or delayed in presentation to the players.

In another aspect, the present disclosure describes a system for operating a wagering game client of a wagering game system. The system includes a processor and a memory having instructions stored thereon, where the instructions, when executed by the processor, cause the processor to receive a player input from a user interface of the system. The instructions, when executed by the processor, further cause the processor to transmit, over a network, to a central processing computing device associated with the wagering game, a player submission. The player submission includes an identifier of the wagering game client and the player input and is synchronized to a clock pulse associated with the first computing device to determine a player token. The player token (e.g., a card, die, or a gameplay piece) is employed as a basis for the determination of an outcome of the wagering game for all the players participating in the wagering game (as opposed to a random or pseudorandom number). In some embodiments, the player submission includes an identifier of the player (e.g. a credit card number or a player identification number). The individual player actions of players within the wagering game are hidden and/or delayed in presentation to the players.

In another aspect, the present disclosure describes a non-transitory computer readable medium for operating a wagering game client of a wagering game system. The computer readable medium has instructions stored thereon, where the instructions, when executed by the processor, cause the processor to receive a player input from a user interface of the system. The instructions, when executed by the processor, further cause the processor to transmit, over a network, to a central processing computing device associated with the wagering game, a player submission. The player submission includes an identifier of the wagering game client and the player input and is synchronized to a clock pulse associated with the first computing device to determine a player token. The player token (e.g., a card, die, or a gameplay piece) is employed as a basis for the determination of an outcome of the wagering game for all the players participating in the wagering game (as opposed to a random or pseudorandom number). In some embodiments, the player submission includes an identifier of the player (e.g. a credit card number or a player identification number). The individual player actions of players within the wagering game are hidden and/or delayed in presentation to the players.

In another aspect, the present disclosure describes a wagering game system having a central processing computing device and a plurality of wagering game clients. Each wagering game client operatively links, via a network, to the central processing computing device and has one or more inputs to receive a wager from a given player in connection with a wagering game. The central processing computing device employs the one or more inputs received at each of wagering game clients as a basis to determine an outcome for all players of the wagering game (as opposed to a random or pseudorandom number).

In another aspect, the present disclosure describes a method for operating a multiple player (e.g., massively multiple player) wagering game system. The method includes receiving over a network, by a processor of a first computing device (e.g. a server), from a first wagering game client, a first player submission. The first player submission corresponds to an input from a user interface (e.g., electronic or electromechanical) of the first wagering game client. The first wagering game client is a member of a plurality of wagering game clients collectively defining the wagering game. The method further includes accessing, by the processor of the first computing device, game data (e.g., game player token) of the wagering game. The game data is employed as a basis to determine a payout and/or winning outcome of the wagering game (as opposed to a random or pseudorandom number), and the individual player actions of players within the wagering game are hidden and/or delayed in presentation to the players. The game data is also is updatable based upon player submissions received from the plurality of wagering game clients. The method includes updating, by the processor of the first computing device, the accessible game data based upon the first player submission. The method includes, responsive to a determination, by the processor, of the accessible game data matching a payout condition for the wagering game, causing a payout outcome for the wagering game to be graphically displayed at the first wagering game client.

In some embodiments, the payout and/or winning outcome of the wagering game is determined based on cumulative actions received from all players of the wagering game (e.g., at the user interfaces of the plurality of wagering game clients). Each action of the cumulative actions is either delayed in being presented (e.g., by a pre-defined delay [e.g., 1 minute]) to other players or not presented to the other players.

In another aspect, the present disclosure describes a system for operating a multiple player (e.g., massively multiple player) wagering game system. The system includes a processor and a memory having instructions stored therein, where the instructions, when executed by the processor, cause the processor to receive, over a network, from a first wagering game client, a first player submission. The first player submission corresponds to an input from a user interface (e.g., electronic or electromechanical) of the first wagering game client. The first wagering game client is a member of a plurality of wagering game clients collectively defining the wagering game. The instructions, when executed by the processor, further cause the processor to access game data (e.g., game player token) of the wagering game. The game data is employed as a basis to determine a payout and/or winning outcome of the wagering game (as opposed to a random or pseudorandom number), and the individual player actions of players within the wagering game are hidden and/or delayed in presentation to the players. The game data is also is updatable based upon player submissions received from the plurality of wagering game clients. The instructions, when executed by the processor, further cause the processor to update the accessible game data based upon the first player submission. The instructions, when executed by the processor, further cause the processor to, responsive to a determination of the accessible game data matching a payout condition for the wagering game, cause a payout outcome for the wagering game to be graphically displayed at the first wagering game client. In some embodiments, the instructions, when executed by the processor, further cause the processor to determine the winning or payout outcome based on cumulative actions received from all players of the wagering game (e.g., at the user interfaces of the plurality of wagering game clients). Each action of the cumulative actions is either delayed in being presented (e.g., by a pre-defined delay [e.g., 1 minute]) to other players or not presented to the other players.

Elements from embodiments of one aspect of the invention may be used in other aspects of the invention (e.g., elements of claims depending from one independent claim may be used to further specify embodiments of other independent claims). Other features and advantages of the invention will be apparent from the following Figs., detailed description, and the claims.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 shows a diagram of a multiple player-connected (e.g., massively multiple player-connected) wagering game system, according to an embodiment.

FIG. 2 shows a function diagram of a wagering game system, according to an illustrative embodiment.

FIG. 3 shows a diagram of a token selection module for generating a game token, according to an illustrative embodiment.

FIG. 4 shows a diagram of a token selection module for generating a card token to be used during the game play, according to an illustrative embodiment.

FIGS. 5-8 show swim lane diagrams illustrating various operations of the wagering game platform, according to an illustrative embodiment. FIG. 5 illustrates a wagering action received by the player. FIG. 6 illustrates data synchronization operations between the client and the data storage server. FIG. 7 illustrates a payout operation by the wagering game system. FIG. 8 illustrates the servicing of a request for extra game information.

FIG. 9 shows a function diagram of a control module for a simple lottery and roulette type game that employs player-action as the basis for determining the payout condition, according to an illustrative embodiment.

FIGS. 10 to 14 are screenshots of an exemplary simple lottery type game, referred to herein as the “Black & White” game. The game allows for the selection by the player of two selectable tokens. The wagering game system awards the player for each wager made by the player to a winning pot (i.e., the pot having the lower aggregated wager) during a pre-defined game session.

FIGS. 15 to 19 are screenshots of an exemplary simple roulette type game, referred to herein as the “Casinova Roulette” game. The game allows for the selection by the player of multiple selectable tokens.

FIG. 20 shows a function diagram of a control module for a reversed lottery and roulette type game that employs player-action as the basis for determining the payout condition, according to an illustrative embodiment. The game allows for the selection by the player of multiple selectable tokens. The wagering game system awards the player for each wager made by the player to a winning pot (i.e., the pot not having the highest aggregated wager) during a pre-defined game session.

FIG. 21 shows a function diagram of a control module for a high-dimension lottery and roulette type game that employs player-action as a basis for determining the winning and payout condition, according to an illustrative embodiment. The game allows for the selection by the player of multiple selectable tokens. The wagering game system awards the player for each wager made by the player to a token having the least frequency of repetition during a pre-defined game session.

FIGS. 22 to 30 are screenshots of an exemplary high-dimension lottery/roulette type game, referred to herein as the “Hi-Lo” game.

FIG. 31 shows a function diagram of a control module for a constant payout slot type game that employs player-action as the basis for determining the winning and payout condition, according to an illustrative embodiment. The player-action drives a global counter maintained by the game until a winning and/or payout condition is met.

FIGS. 32 to 35 are screenshots of a first exemplary constant payout slot type game, referred to herein as the “Magic 9” game.

FIGS. 36 to 39 are screenshots of a second exemplary constant payout type game, referred to herein as the “Devil 6” game.

FIG. 40 shows a function diagram of a control module for higher-dimension slot type game that employs player-action as the basis for determining the winning and payout condition, according to an illustrative embodiment.

FIGS. 41 to 44 are screenshots of an exemplary high-dimension slot type game.

FIG. 45 shows a function diagram of a control module for sequence-based type game that employs player-action as the basis for determining the winning and payout condition, according to an illustrative embodiment.

FIGS. 46 to 49 are screenshots of an exemplary sequence-based type game, referred to as “RGB”.

FIGS. 50 to 52 are screenshots of a second higher-dimension game, referred to as “lotto scratch”.

FIG. 53 is a block diagram of an exemplary cloud computing environment, for use in illustrative embodiments of the invention.

FIG. 54 is a block diagram of an example computing device and an example mobile computing device, for use in illustrative embodiments of the invention.

FIGS. 55A and 55B illustrate the generation of random winning tokens in game such as lotto, according to an exemplary embodiment.

FIG. 56 illustrates a social gaming platform according to an exemplary embodiment. The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

It is contemplated that systems, devices, methods, and processes of the claimed invention encompass variations and adaptations developed using information from the embodiments described herein. Adaptation and/or modification of the systems, devices, methods, and processes described herein may be performed by those of ordinary skill in the relevant art.

Throughout the description, where articles, devices, and systems are described as having, including, or comprising specific components, or where processes and methods are described as having, including, or comprising specific steps, it is contemplated that, additionally, there are articles, devices, and systems of the present invention that consist essentially of, or consist of, the recited components, and that there are processes and methods according to the present invention that consist essentially of, or consist of, the recited processing steps.

It should be understood that the order of steps or order for performing certain action is immaterial so long as the invention remains operable. Moreover, two or more steps or

actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

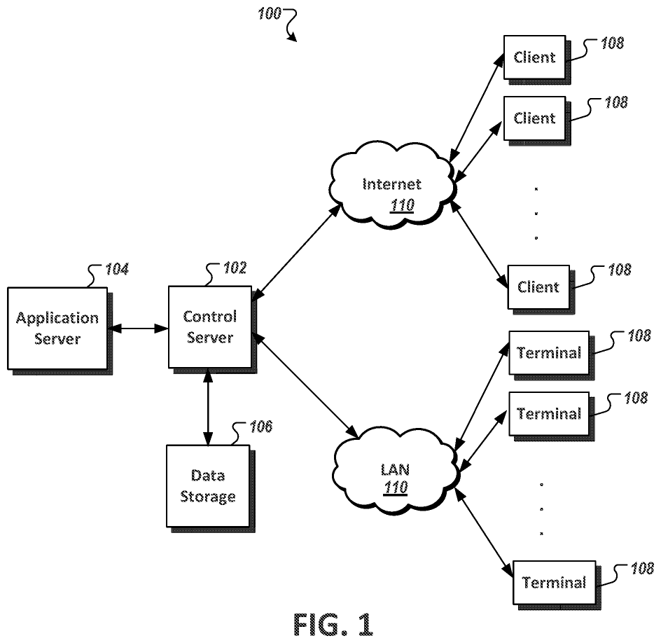

FIG. 1 is a diagram of a massively-connected wagering game system 100. The wagering game system 100 includes a control server 102 operatively coupled, through one or more networks 110, to a vast number of wagering game clients 108.

The control server 102 includes, in some embodiments, one or more servers to share the load associated with the connectivity to the wagering game clients 108. The wagering game clients may operate on a general computing device, shown as a “client 108”, or a wagering game terminal, shown as a “terminal 108.” In such embodiments, the control server 102 controls the action of the game and coordinates the game actions with application server 104 and data storage server 106. The servers may be logical/virtual or physical computing devices.

In some embodiments, the wagering game client 108 comprises a Web application that is executable from a Web browser of the computing device. In other embodiments, the client comprises a client application or a browser plug-in that is installed on the computing device. Examples of computing devices operating the wagering game client 108 include, but are not limited to, a mobile device, smart phone, cellphone, laptop, tablet, desktop, game console, and other electronic devices that include a graphical user interface and can be operatively linked to the game network to create the massively-connected system of gaming devices. Other examples of computing devices operating the wagering game client 108 include, but are not limited to, slot machines, video slot machines, video gaming machines, and other types of gaming systems as used in gambling and wagering establishment or facility, such as a Casino. In some embodiments, the computing devices include an electronic graphical user interface and/or electromechanical inputs (e.g., buttons or lever) to capture inputs from the player. In other implementations, the mobile device 102 further includes sensors (such as a capacitive touchscreen input, microphone, camera, an accelerometer, and/or a gyroscopic sensor) configured to interpret the readings of the sensors to detect player actions mapped to such sensor readings.

The networks 110 may include, but not limited to, the Internet, a Wide-Area Network, and a Local Area Network. In some embodiments, a persistent network connection is maintained between the wagering game client 108 and the control server 102 after the wagering game client 108 is authenticated. The wagering game client 108 allows players to simultaneously access the game in real-time along with the other players. In some embodiments, the wagering game clients 108 operatively connect to the control server 102 via a secured and closed local area network. In other embodiments, the wagering game clients 108 operatively connect to and/or communicate with the control server 102 using encrypted messages and protocol (e.g., HTTPS, SSL/TLS) within a unsecured and open network 110.

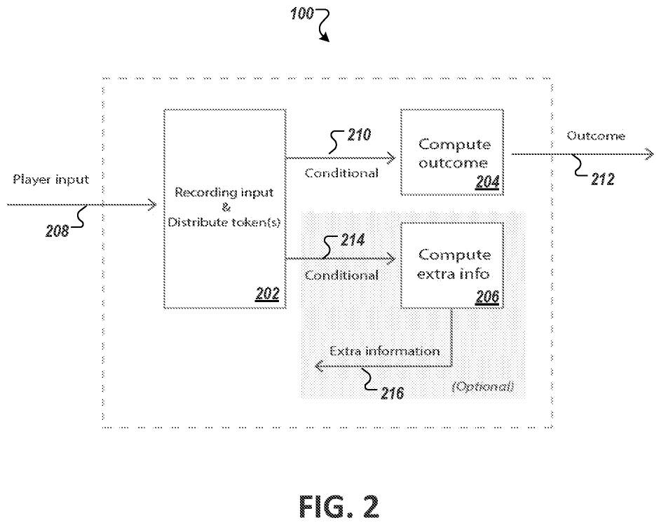

FIG. 2 shows a function diagram of a wagering game system 100, according to an illustrative embodiment. In some embodiments, the wagering game system 100 includes a recording input module 202 to receive a player submission 208 corresponding to the player-action (e.g., placed wager, selected wager option, wager amount) made by the player in connection with a game. The recording input module 202 also distributes, in some embodiments, game token 210 to be used to determine a payout outcome of the game. The game tokens 210 are generated based on player action received preferably via inputs of a graphical user interface (e.g., a button, scroll bar, levers, keypad, dial, scroll wheel, etc.) associated with a respective wagering client 108 for a given player. In some embodiments, the player action is a recordable physical movement, for example, from a camera, gyroscopic, or accelerometer sensor. In some embodiments, the player submission 208 is implemented in the control server 102 and is buffered, e.g., in a FIFO, at the control server 102 before being processed.

The game token 210 allows the player actions associated with all the players within a game session of the massively-connected wagering game system to be synchronized and sequenced in a queue in relation to one another.

A clock pulse associated with the server is employed for the synchronization with the players action (e.g., act of wagering and/or wager amount). The clock pulse may be an digital clock signal, a digital timer, or a digital counter. In some implementations, the clock pulse is a signal that oscillates between a high and a low state and is used to coordinate action of the game. The triggering of the upward edge, the downward edge, or the actual state may be used to synchronize (e.g., an AND operator) with the player action. In other implementations, the clock pulse is a digital timer having, for example, a millisecond count, a second count, a minute count, an hour count, etc. In yet other implementations, the clock pulse is a counter having, for example, a millisecond count. The clock pulse may represent absolute time or may represent a relative time from, for example, when the game is initiated. Of course, finer resolution of time below milliseconds, such as, for example, but not limited to, nanosecond may be employed.

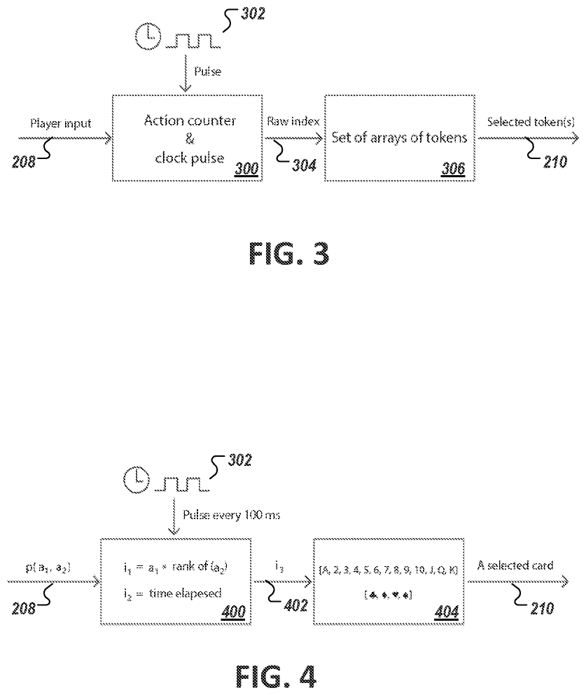

FIG. 3 shows a diagram of an exemplary game token generation module 300 (shown as “action counter & clock pulse” module 300) for generating the selected game token 210. FIG. 4 shows a diagram of another exemplary game token generation module.

In some embodiments, the game token generation module 300 is implemented in the control server 102. In some embodiments, the game token generation module 300 combines, compares, and/or synchronizes the received player submission 208 with a clock pulse 302 associated with the control server 102. No random or pseudorandom number generator is used, nor any kind of external seed, to compute for the game player token 210.

The player submission 208, in some implementations, includes an action identification symbol (e.g., numerical, string, alphanumerical, and other data representation), which characterizes a given player action. In some embodiments, the action identification symbol corresponds to or is indicative of a wager amount made by the player. Each wagering game client 108, in some embodiments, maintains a database or library of symbols, which are mapped to a player-action specific to that symbol.

In some embodiments, the player submission 208 also includes a client identification symbol and/or player identification symbol. The client identification symbol allows the system to identify the transmission source of the player submission. In some embodiments, the client identification symbol includes a portion of the network address of the wagering game client 108. The player identification symbol allows the system to identity the player making the player submission 208. The client identification symbol and/or player identification symbol are represented, in some embodiments, as an alphanumerical string or a binary string.

Referring still to FIG. 3, in some embodiments, the clock pulse 302 is an internal clock signal, pulse train, clock data value, or pulse data value available within the control server 102. In some embodiments, the control server 102 includes an auxiliary circuit or board that provides the clock pulse to the digital bus of the control server 102 (e.g., PCI, PCI-express, etc.). In some embodiments, the clock pulse has a period preferably between the range of 100 milliseconds (ms) and 1 nanosecond (ns). In other embodiments, higher frequency clock pulse maybe employed.

As shown in FIG. 3, the game token generation module 300 receives the player submission 208 and produces a raw index value 304 (shown as “raw index” 304) based on the clock pulse 302. In some embodiments, the raw index value 304 is employed as an index to retrieve a value in a look-up table, a hash table, or other types of indexed data structure. In certain embodiments, the game token generation module 300 is implemented within the recording input module 202. In other embodiments, the game token generation module 300 operates in conjunction with the recording input module 202.

In some embodiments, the player submission 208 is employed to increment, at an edge of the clock pulse 302, a counter maintained in the raw output value 304. That is, at each clock pulse edge, the value of the counter is changed (i.e., incremented or decremented) by one (and, in some instances, the value of the wager amount associated with the player submission). In other embodiments, the player submission 208 includes a varying value (e.g., corresponding to wager amount) to which the counter of the token generation module 300 is arithmetically updated. The updated counter value may be operated upon, for example, by a modulus operator corresponding to the number of the selectable token) to generate the raw index value 304.

For illustrative purposes, an example generation of a token 210 from a player submission 208 is now described. A player submission 208 is received from Player 1 at the game token generation module 300, which has an initial and current counter value of “0”. Upon receipt of the player submission, the global game counter is incremented to “1.” A modulus operand of “2” is applied to the global game counter (having a value of “1”), type casted as an INTEGER. The result of the global game counter having a value “one” operated by a modulus operand of two (having a symbol of “1% 2”) produces a resulting raw index value 304 of “1.” The lookup table 306, in this example, has two selectable token corresponding to two entries in the table (“0” and “1”) that is indexed by the values (“0” and “1”). Consequently, the raw index value 304 of “1” when mapped to the lookup table 306, results in a value of “1” as the selected token 210, which is arithmetically updated (e.g., by an addition or increment operand) to the global game counter.

The above example may be applied to a deck of cards or a die. For example, for a deck of 52 cards, the number of selectable token is “52”. The global game counter may be operated by a modulus of 52 to produce an index value 304 that maps to 1 of 52 card value stored in the lookup table 306. Moreover, it should be understood that a player submission may be received from multiple players participating in a game, match, or the like. It should also be understood that discarding of a selectable token, in some example embodiments, correspond to the selection of all of the other non-discarded tokens.

Referring now to FIG. 4, another exemplary game token generation module 400 is now described. As shown, the player submission 208 is based on both a wager amount submitted by the player (“a1”) and an order sequence number (“a2”) associated with the player submission 208 in relation to other player submissions, shown as “p(a1, a2)” An integer i1 is calculated as the wager amount submitted by the player a1 multiplied by a rank value associated with the ordered sequence of the wager a2, as shown in Equation 1.

i1=a1*ranking of (a2) (Equation 1)

The output of the integer i1 is synchronized to the clock pulse 302. In addition, an integer i2 corresponding to the time from the start of the game session is generated, as shown in Equation 2.

i2=time elapsed (Equation 2)

The game token generation module 400 generates an integer i3 as the sum of i1 and i2, as shown in Equation 3.

i3=i1+i2 (Equation 3)

The output i3 may be operated by a modulus operation to map i3 to one or more pre-defined set of array values, e.g., those corresponding to a card or a die. Example, a modulus of “52” may be employed to correspond to 52 cards. In instances that a particular card or die cannot be drawn (because the card exists in a hand of another player), the amount of raw index, in some embodiments, is increased by “one” index or symbol until an available card or die can be drawn.

Alternatively, the game token generation module 400 generates the integer i3 as the combination of i1 and i2 (i.e., i3=[i1, i2]). Each element of integer i3 is operated by a modulus operation that map each of the elements to a respective card number and card suit. The first integer i1 is mapped, for example, to indexes corresponding to a card value (e.g., “1”, “2”, “3”, “4”, “5”, “6”, “7”, “8”, “9”, “10”, “J”, “Q”, and “K”), and the second integer i2 is mapped to indexes corresponding to the card suits (e.g., “clubs”, “diamonds”, “hearts”, “spades”). In case that a particular card value and suit combination has already been assigned, an index value may be increased by “one” until an available card can be drawn.

Referring back to FIG. 2, the recording input module 202 interfaces to and shares the game processing with a computation module 204 (shown as “compute outcome” module 204) and a second computation module 206 (shown as “compute extra info” module 206). The computation module 204 determines and/or calculates the payout outcome of a given game. The second computation module 206 determines and/or calculates responses to intermediary and/or auxiliary game actions from the player (e.g., request and/or purchase of game information). In some embodiments, the computation module 204 and second computation module 206 are implemented in the application server 104. In other embodiments, the recording input module 202 and computation modules 204, 206 are implemented on a single logical/virtual or physical computing device.

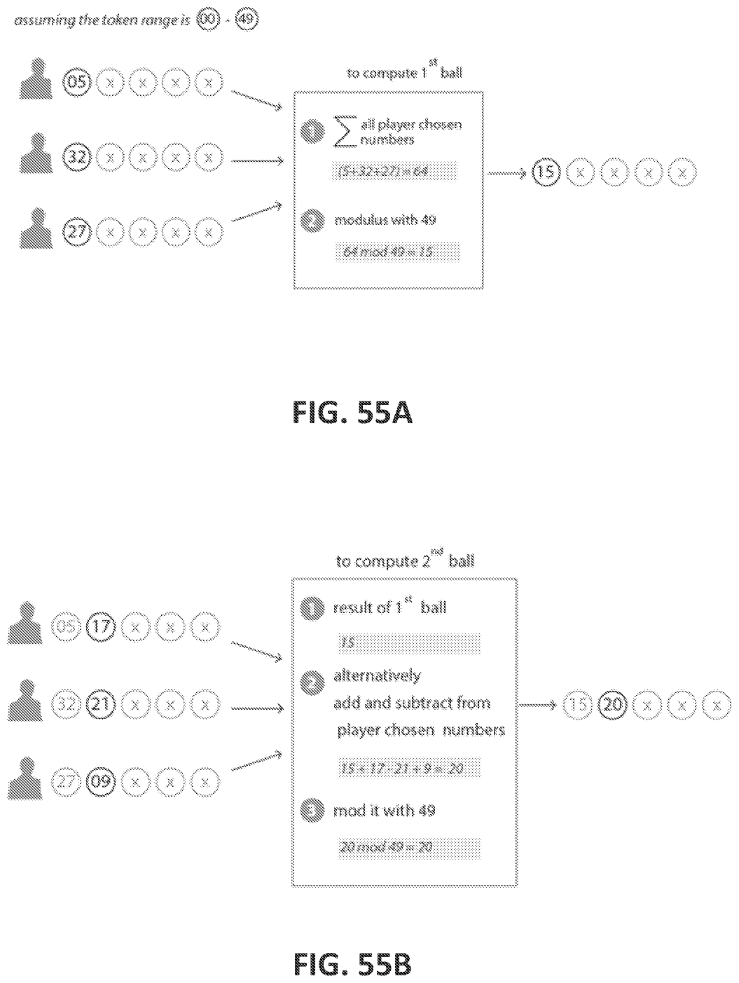

In some example embodiments, player submissions (e.g., player chosen number, token, image, and the like) are used to obtain the outcome and/or chosen token (e.g., number, ball, image, icon, etc.) in a wagering game (e.g., lotto). FIGS. 55A and 55B illustrate the generation of random winning tokens in game such as lotto, according to an exemplary embodiment.

As shown in FIG. 55A, three players participate in a wagering game (e.g., lotto), in which the winning token range can be any number from 00 to 49. A first player selects a first (e.g., of five token slots to be filled) token 05; a second player selects a first token 32; and a third player selects a first token 27. The selected first tokens by the players are transmitted to a token generation module, where a winning first token (e.g., ball) is calculated and/or determined. As shown in FIG. 55, in one example embodiment, the sum of the first tokens selected by the players (e.g., 64 (e.g., 5+32+27)) is calculated. In turn, a modulus operation is performed using the sum of the first tokens selected by the players (e.g., 64) and the highest possible token among the token range of tokens to be selected and/or randomly determined (e.g., 49). The result of the modulus operation (e.g., 64 mod 49=15) is used as the winning token, as shown in FIG. 55.

In turn, as shown in FIG. 55, the players select a second token. As shown in FIG. 55, the selected second token of the first player is 17; the selected second token of the second player is 21; and the selected second token of the third player is 09. The selected second tokens are sent to the token generation module. In turn, to determine the second winning token, the token generation module adds and subtracts (e.g., back and forth) a number of values, including the value of the first winning token (e.g., 15) and the selected second tokens of each player (e.g., 17, 21, 9), thereby obtaining a result of 20. The result (e.g., 20) is used in a modulus operation with the highest possible token among the token range of tokens to be selected and/or randomly determined (e.g., 49). The result of the modulus operation (e.g., 20 mod 49=20) is used as the winning second token, as shown in FIG. 55. This process can be repeated for each additional winning number in the game (e.g., five winning tokens in the game illustrated in FIG. 55).

It should be understood that this process can be used to also generate, in addition to winning tokens/outcomes, the winning rate, cost, payout, jackpot, etc. It should also be understood that other arithmetic operations and numbers can be used in the above example.

In some embodiments, upon receipt of the player submission of a given player, the control server 102 directs and/or relays the player submission to the application server 104 to calculate and/or determine one or more game player tokens 210 specific for that player.

Game player tokens 210 are game data and/or games data messages that are computed and/or determined from a player-action and used as a basis to determine winning and/or payout conditions for each and, in some embodiments, all of the players. No random or pseudorandom number generator is used, nor any kind of external seed, to compute for the game player token.

In some embodiments, each game player token 210 is associated with a given player and is used to calculate a payout token 212 employed to track a payout instance for that player. The payout instance 212 may be performed at the end of a given game session or during the game session following the generation of each game player tokens 210.

In some embodiments, the game player tokens 210 and payout tokens 212 are associated with an identification number corresponding to the client 108 or player 504. The game player token 210 may also be associated with a wager amount submitted within a player submission 208.

In some embodiments, the game player tokens 210 and payout tokens 212 are recorded at the data storage server 106 for quality control and auditing purposes, among other reasons. The data storage server 106 may record the game player tokens in a relational database, a persistent data table or data array, or a data file. In certain embodiments, the game player tokens 210 and/or payout tokens 212 are used to generate a profile of the player. The profile may be updated on a periodic basis (e.g., daily, weekly, etc.) or following each game session.

Referring still to FIG. 2, the second computation module 206 is employed to determine and/or calculate responses 216 to a request 214 for game session information. The responses may be presented as a game status of a given selectable game token, for example, but not limited to, whether the token is winning and/or losing. A player can employ such information to, for example, place additional wagers on their winning game token to increase the payout, and/or place wagers on a game token to improve the chance of their game token winning. The second computation module 206 may be implemented in the control server 102.

During a given game session, only information specific to a player action of a given player is presented to the player, by default, to provide acknowledgement of the player action and/or wager made by that player. Information of player actions specific to other players are either hidden from (i.e., not available and/or displayed to) the individual player or delayed in the availability and/or presentation of such information. The non-availability of the information creates an information blackout and provides uncertainty for the wagering game. The request 214 for additional information may provide summarized status of the game, but not individual game actions of the players.

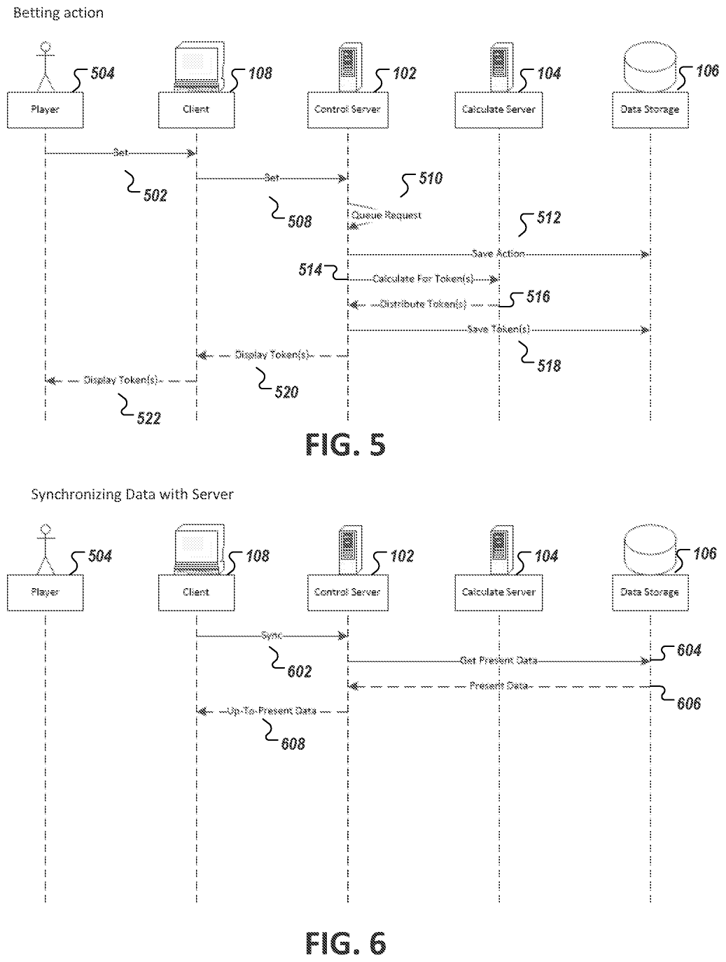

FIGS. 5-8 show swim lane diagrams illustrating various operations of the wagering game platform, according to an illustrative embodiment. Referring to FIG. 5, a swim lane diagram illustrating a wagering sequence operation from a received player wager, is now described. During game play, a received wager action 502 (shown as “bet” 502) from a player 504 is received at one or more inputs of the graphical user interface of the wagering game client 108. The client 108 associates the action 502 with an identification number specific to the client 108 or to the player 504 within a player submission 208 and transmits the player submission 208 to the operation server 102 (shown as “bet” 508).

The control server 102 receives the player submission 508 and queues the submission in a buffer (shown as “queue request” 510). A game player token 210 is generated in accordance with the process described in relation to FIG. 3 or FIG. 4. The control server 102 directs the game player token 210 to the data storage server 106 (shown as “save action” 512) for storage and also directs the player submission 208 to the application server 104 to calculate a payout token 212 (shown as “calculate for token(s)” 514).

The application server 104 determines if a payout token 212 is generated from the received game token 210. The application server 104 transmits the payout token 212, if generated, back to the operation server 102 (shown as “distribute token(s)” 516). The payout token 212 is saved (shown as “save token(s)” 518) to the data storage server 106. The payout token is also transmitted to the client 108 (shown as “display token(s)” 520). The client 108 uses the payout token 212 to graphically indicate to the player of a payout outcome (shown as “display token(s)” 522) through the device graphical user interface. In some embodiments, the presentation of the payout token 212 at the client 108 is delayed by at least a pre-defined time window from the time the player input is received.

Referring now to FIG. 6, a swim lane diagram illustrating data synchronization operations between the client 108 and the control server 102 is shown. The synchronization operation, in some implementations, is employed as a security function to ensure that a given client 108 has not been tampered or cloned. The synchronization operation, in some embodiments, is performed on a periodic basis. The synchronization operation may include the client 108 transmitting a security message, on the periodic basis, to be compared to an expected security message at the control server 102 or an authentication server.

The client 108 initiates a synchronization operation, in some embodiments, and transmits a synchronization request message to the control server 102 (shown as “sync” 602). Upon receipt of the request 602, the control server 102 sends a data request 604 to the data storage server 106 (shown as “get present data” 604). The data storage server 106 returns the requested data 606 to the control server 102 (shown as “present data” 606), and the requested data 606 is relayed to the client 108 (shown as “up-to-present data” 608).

Referring now to FIG. 7, a swim lane diagram illustrating a payout or game end condition being satisfied is shown. In certain embodiments, the game end condition includes the timer of the game session meeting the end of the game time. In such embodiment, a incrementing or decrementing counter/timer is employed. In other embodiments, the game end condition is met when a payout condition is met, for example, when a payout token 212 is generated.

In some embodiments, upon the control server 102 determining that the winning condition or payout condition is satisfied (shown as “game end” 702), the control server 102 transmits a game result request to the application server 104 (shown as “calculate game result” 704). In some embodiments, the winning condition occurs when a current game token meeting a payout condition specific to the game. In other embodiments, the winning condition is the end of the game session and corresponds to the pre-defined elapse of time by the game timer.

The request may include the payout token 212 for one or more of the players. The application server 104 calculates the game result and directs the result to the control server 102 (shown as “game result” 706). The control server 102 distributes the respective game result for each player to the respective client 108 (shown as “game result” 708) and directs the game result to the data storage server 106 (shown as “save game results” 708). The client 108 graphically displays the game result to the player 504 (shown “game result” 712).

In some implementations, the game results for all the player submissions in a given game session are made available (e.g., for download) following a game session. In some implementations, the game results are presented in a table, graph, or the like. The presented data includes, for example, but not limited to: wager amount, a time associated with a wager, and/or a selected game option. The presented data may include identifiers of the players associated with each player submission. Indeed, the identifiers may be display actual user name associated with a given player. In other implementations, the game results are downloadable, following the conclusion of the game, as a table data (e.g., in text or spreadsheet format). It is intended that the game results can be analyzed, following a given game, for audit and/or study purposes.

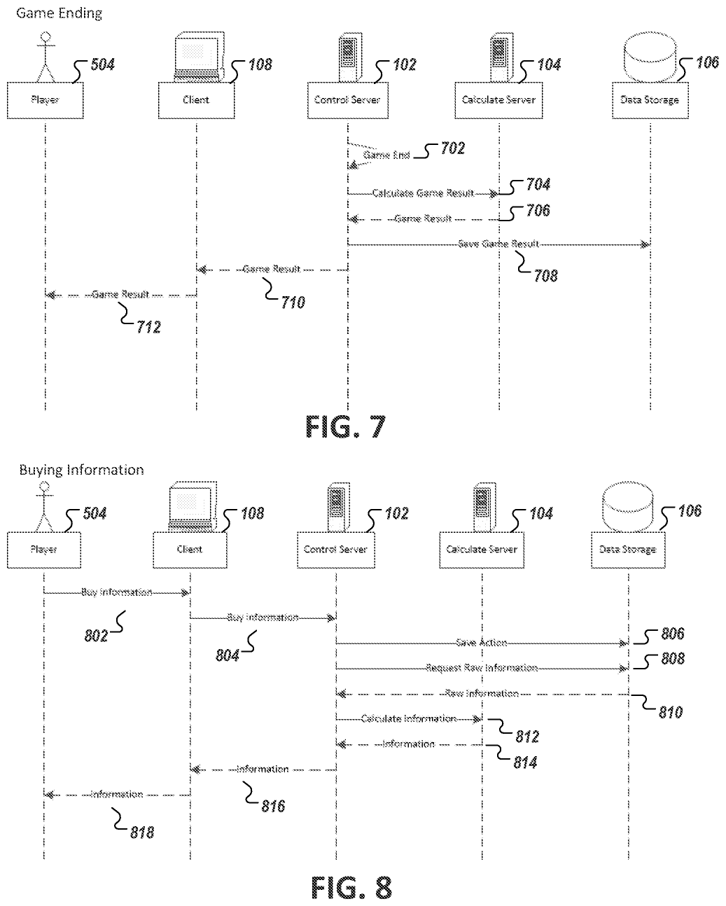

Referring now to FIG. 8, a swim lane diagram illustrating service for a request for extra game information is shown. Upon a player action 802 (shown as “buy information” 802) being received at the client 108, the client 108 transmits the request 804 to the control server 102. The client 108 transmits the request to the control server 102 (shown as “buy information” 804).

The control server 102 queues the request, upon receipt, and transmits the request to the data storage server 106 (shown as “save action” 806) and transmits the request for the game play information to the data storage server (shown as “request raw information” 808). In some embodiments, actions 806, 808 are transmitted in a single request message.

The data storage server 106 processes the request (806, 808) and returns the requested raw data to the control server 102 (shown as “raw information” 810).

The control server 102, in turn, relays a request for game information, along with the retrieved raw data, to the application server 104 (shown as “calculate information” 812). The application server 104 processes the request for game information 214 and returns response 216 comprising the game status information to the control server (shown as “information” 814). The control server relays the game status information to the client (shown as “information” 816), and the information is graphically presented to the player 504 (shown as “information” 818) via the graphical user interface.

While the present disclosures have been described in conjunction with various embodiments and examples, it is not intended that they be limited to such embodiments or examples. On the contrary, the disclosures encompass various alternatives, modifications, and equivalents, as will be appreciated by those of skill in the art. Accordingly, the descriptions, methods and diagrams of should not be read as limited to the described order of elements unless stated to that effect.

Although this disclosure has described and illustrated certain embodiments, it is to be understood that the disclosure is not restricted to those particular embodiments. Rather, the disclosure includes all embodiments that are functional and/or equivalents of the specific embodiments and features that have been described and illustrated.

### Example #1: Simple Lottery and Roulette (e.g., the “Black & White” Game)

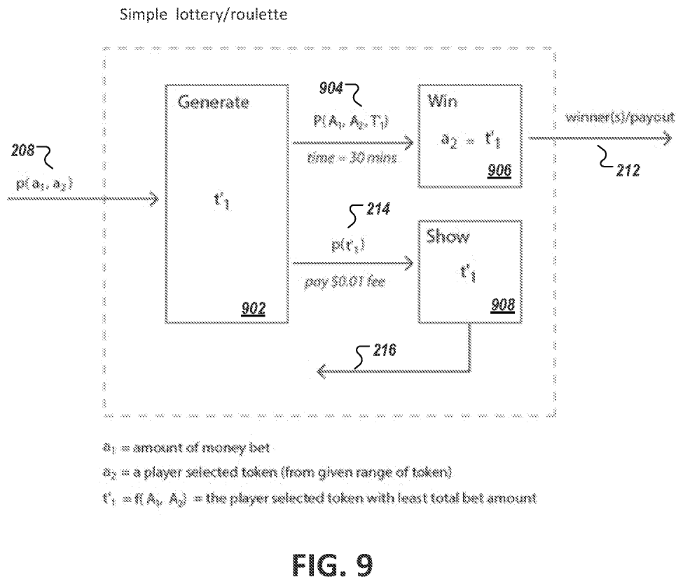

FIG. 9 shows a function diagram of a control module for a simple lottery and roulette type game that employs player-action as the basis for determining the payout condition, according to an illustrative embodiment. The wagering game system awards the player for each wager made by the player to a pot having the lowest aggregated wager amount from among the selectable token available for selection by the player.

A game module 902 receives a player submission 208 (shown as “p(a1, a2)” 208) associated to a player action. The game module 902 includes, in some embodiments, the recording input module 202 and computation module 204, as described in relation to FIG. 2. The player submission 208 includes a wager amount a1 made by the player and a selected game token a2, associated with the wager amount a1. The game module 902 determines the game token 210, as described in relation to FIG. 5, and updates one of two global game counters maintained by the game module 902 with the game token 210. The game module 902 determines a selected game token having the least total wager amount (shown as “f1”) based on a comparison of the two global game counters. One of the two global game counters, in some embodiments, is designated, by default, as the selected game token having the least total wager amount. In instance of a tie following an update (namely, both global game counters having the same wager amount), the default global game counter is used as the selected game token“t′1”.

In this example, the global game counter corresponds to the selectable game token, which is “black” or “white”. Of course, other types of binary-related symbols can be employed in other embodiments.

In some implementations, each global game counter includes a frequency at which wagers are placed to a given game token. In other implementations, the global game counter is maintained by the game module 902 as the total wager amount that has been placed to a given game token. That is, the global game counter is the total pot size for a given game token.

The game module 902 provides the selected game token information (shown as “P(A1, A2, T′1”) 904) to a payout module 906. The payout module 906 determines if the game token (“a2”) 210 corresponding to the game player action matching the selected game token having the least total wager amount (“t′1”). Upon a match, the payout module 906 outputs a payout token 212. The least total wager amount (“t′1”) includes the wager of the player submission 208. In having the least total wager amount (“t′1”) including the wager of the player submission 208, the payout is ensured to be covered by wagers placed during the game session.

In some embodiments, the payout module 906 calculates the payout token 212 at the end of the game time period. Alternatively, the payout module 906 calculates the payout token 212 following each instant that a player action is received. The presentation of the game and/or winning outcome to the player, including the result of the payout token 212, is preferably delayed, for example, by a fixed time window. The payout associated with a payout token 212 may have up to a multiplier of “2” (i.e., the payout is 1:2). That is, for each $1 wager placed, the payout is twice that amount.

Referring still to FIG. 9, a second computation module 908 computes any request for game information 214 that is received. A fee is transacted to a player account associated with the request. The response 216 to the request 214 includes the selected game token having the least total wager amount (“t′1”). In some embodiments, the information is presented as the token that is currently winning. The fee can be between $0.01 and up to a wager unit (e.g., “$1”), for example, but not limited to, “$0.01”, “$0.05”, “$0.10”, “$0.15”, “$0.20”, “$0.25”, “$0.30”, “$0.35”, “$0.40”, “$0.45”, “$0.50”, “$0.55”, “$0.60”, “$0.65”, “$0.70”, “$0.75”, “$0.80”, “$0.85”, “$0.90”, “$0.95”, and “$1.00”. In some embodiments, the fee is preferably around “$0.01.” In other embodiments, the fee is preferably around “$0.50.”

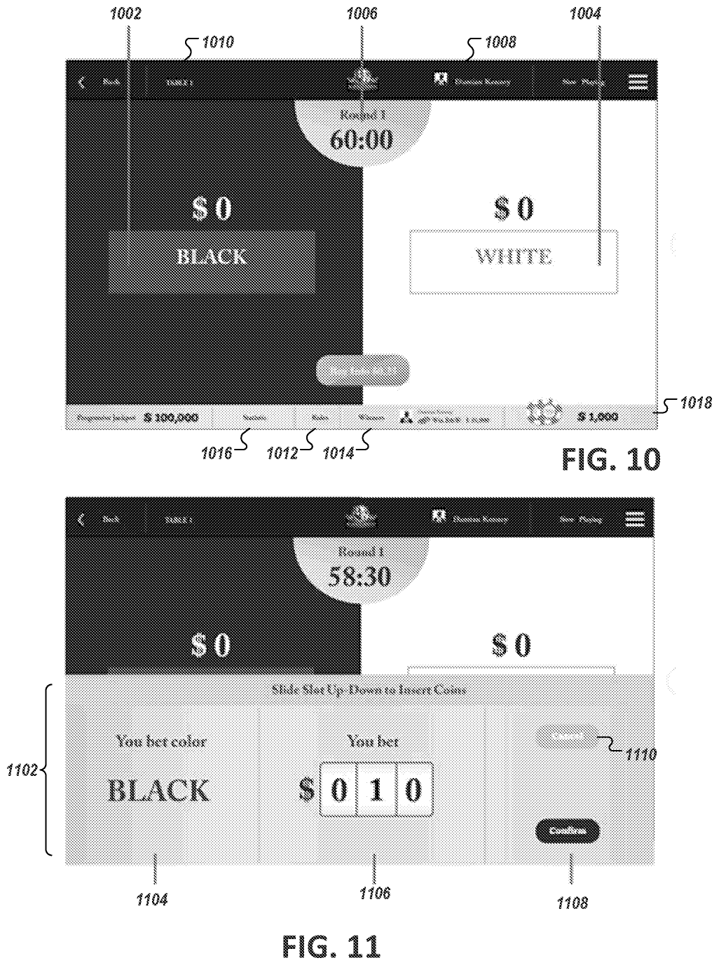

FIGS. 10 to 14 are screenshots of an exemplary simple lottery type game (also referred to as “Black and White”), as described in relation to FIG. 9. The game allows for the selection by the player of two selectable tokens and awards the player for each wager made by the player to a winning pot (i.e., the pot having the lower/lowest total wager). The game may initiate selectable tokens being presented to the player, including: “black token” 1002 and “white token” 1004. The game session time 1006 is also presented. In this example, the payout is made at the end of the game session.

To place a wager, the player selected one of the selectable game token. A wager sub screen 1102 then appears, as shown in FIG. 11. The wager screen 1102 indicates the selected token 1104, a wager widget 1106, a wager confirmation button 1108, and a wager cancel button 1110. As shown, the wager widget 1106 is a slider wheel widget that can be adjusted based on a sliding action over the widget 1106. In some embodiments, the wager amount 1106 may be adjusted as a key-pad widget or simple push button widgets with one or more pre-defined wager amounts.

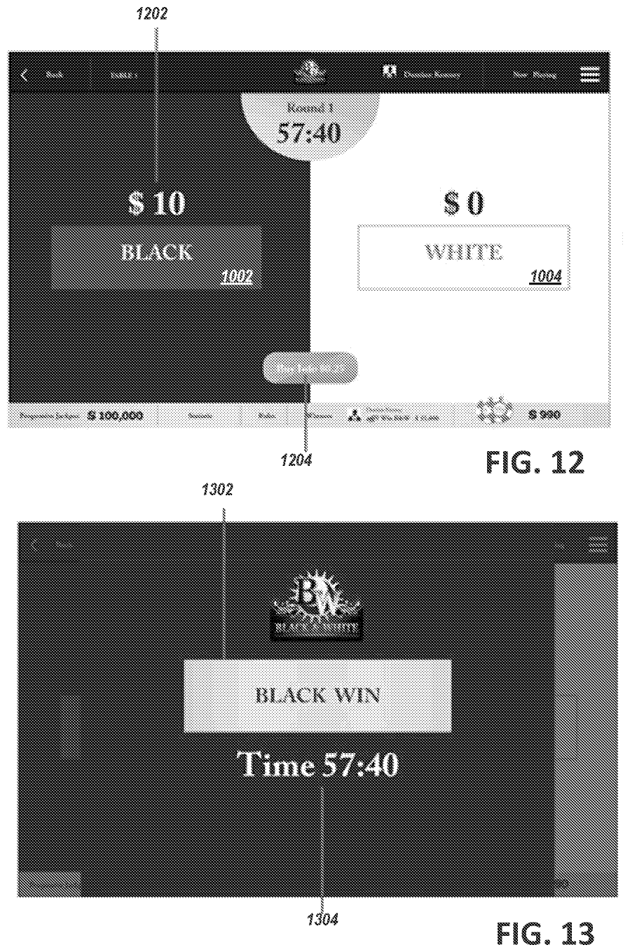

Following a wager, the game screen is updated to show the wagers made to a given pot by the player, as shown in FIG. 12. Here, the “black” token 1002 is shown with a wager value 1202 of “$10” corresponding to the wager made. Also shown in FIG. 12 is a “buy info” widget 1204. The widget 1204 allows the player to buy game information.

Upon a selection of the buy information option 1204, the system displays the requested game information, as shown in FIG. 13. The response to the game information request includes the currently winning token 1302 and the remaining time 1304 in the game. As shown, the “Black” token is indicated to be winning. This indicates that the Black token has a lower wager pot as compared to the White token pot and corresponding to the lowest aggregated wagering amount.

Referring back to FIG. 10, the system may graphically display an identity of the player 1008, an identifier of the game location 1010, as well as options to view the game rules 1012, past winners 1014, statistics of past games 1016, and the player's current funds 1018.

In some embodiments, the player's current funds 1018 may be displayed as a multiple of actual money in the player funds. For example, $10 may be provided as $1,000 game points. In other embodiments, the player's current funds 1018 reflect actual money units that are available within the player's account.

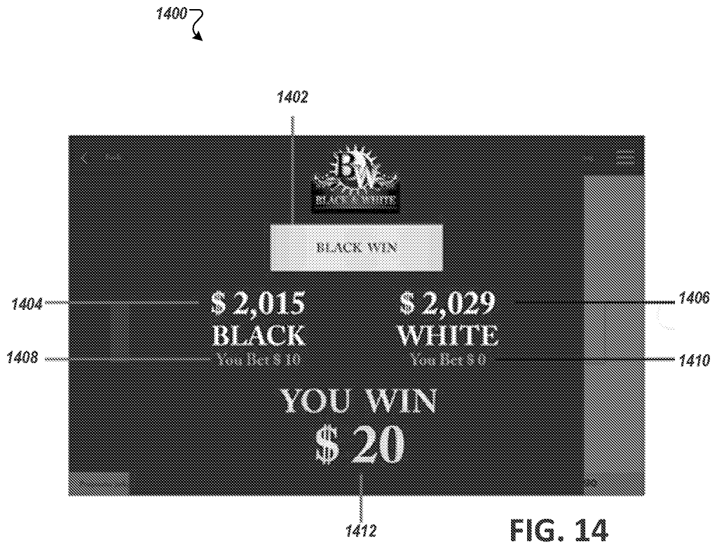

FIG. 14 shows a payout summary 1400 for a given game, according to an embodiment. The summary 1400 indicates the winning token 1402, the total amount of wager placed to a given selectable token (1404, 1406), the total wager placed by the player to each of the selectable token (1408, 1410), and the payout amount (1412). The wager information (1404, 1406) provides transparency to the player as to the condition that determines the payout for the game. The wager information (1404, 1406) is stored in the data storage server 106, for example, for auditing reasons.

### Example #2: Simple Lottery and Roulette (e.g., the “Casinova Roulette” Game)

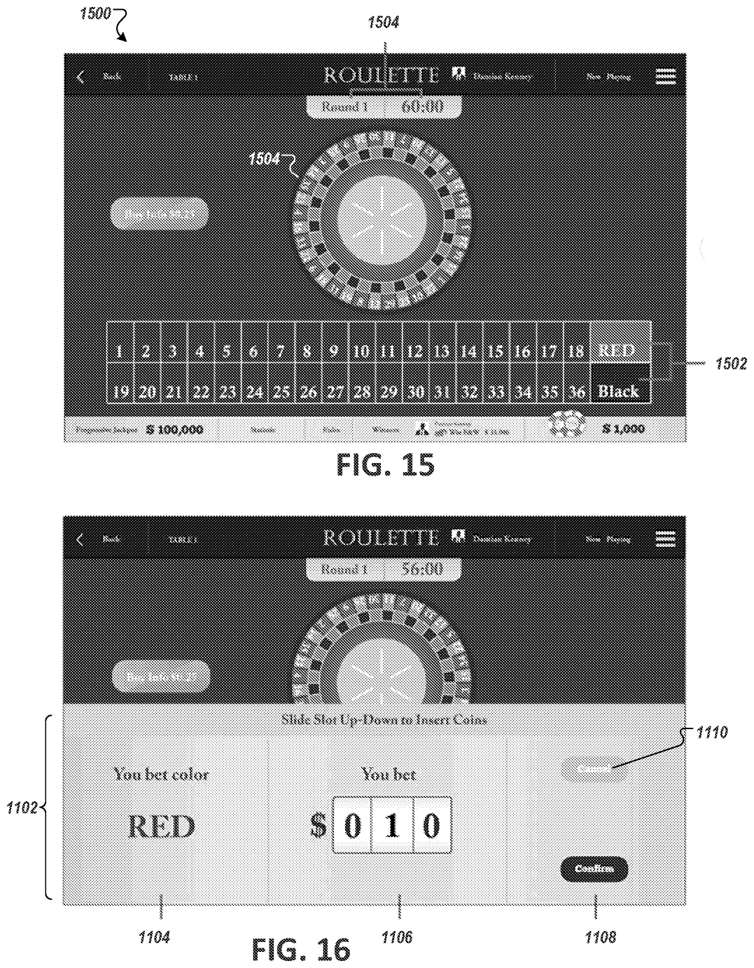

FIGS. 15 to 19 are screenshots of an exemplary simple roulette type game (also referred as the “Casinova Roulette” game), as also described in relation to FIG. 9. The game allows for multiple selections of different types of tokens, for example, based on “numbers” and “colors.” The game may initiate by graphically presenting a roulette table having a roulette wheel and a roulette betting area. As opposed to a random or pseudorandom number, the outcome is determined based on the sequence of wagers placed by the players and the wager amount, as described in relation to FIG. 4.

As shown in FIG. 15, the system graphically presents selectable options 1502 for players to place wagers. Here, the selectable options 1502 are shown as “black” and “red” and numbers “1” through “36”. The options are graphically shown in the roulette wheel 1504. The graphical user interface 1500 also graphically presents a timer 1504 indicative of the remaining time in the game.

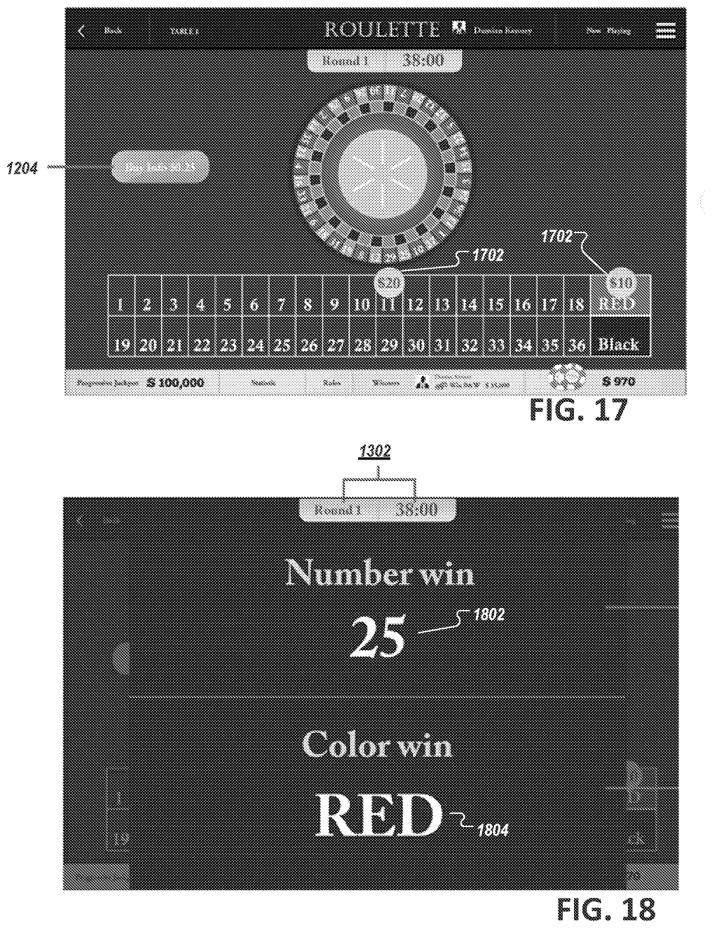

Upon a selection by the player of token 1502, a wager sub screen 1102 is provided, as shown in FIG. 16. The wager screen indicates the selected token 1104 in which the wager is to be applied, a wager amount 1106, a wager confirmation button 1108, and a wager cancel button 1110. Once a wager is placed, the graphical user interface 1500 indicates the total wager amount 1702 for each respective token, as shown in FIG. 17.

Player can buy game information, as described in relation to FIG. 12. FIG. 18 shows the requested game information for each of the token type. Here, the currently winning number 1802 and currently winning color 1804 are shown along with the remaining time in the game 1302.

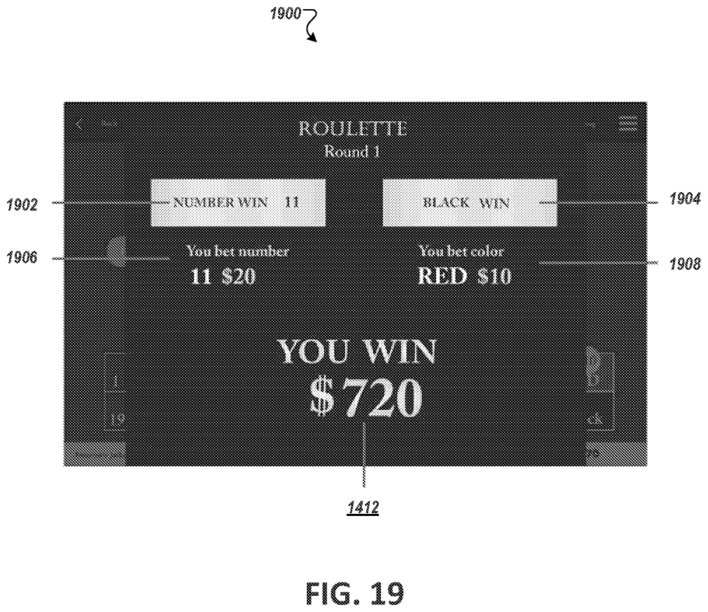

FIG. 19 shows a payout summary 1900, according to an embodiment. The summary 1900 indicates the winning tokens 1902, 1904 for each token type, the total amount of wager placed to a given selectable token (1906, 1908), and the payout amount (1412). The payout amount may be a function of the selectable options 1502. For example, where there are “36” selectable options, the payout may be 1:35 (that is, for each “$1”, the payout is “$35”).

### Example #3: Reversed Lottery and Roulette Game

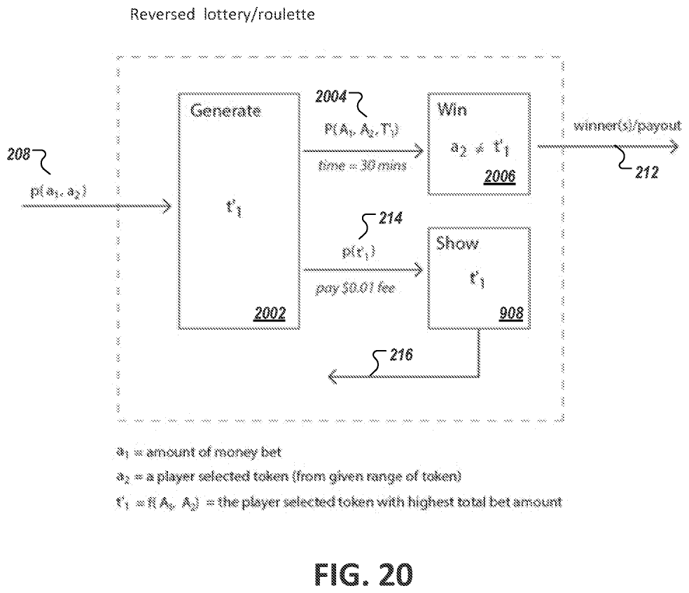

FIG. 20 shows a diagram of a control module for a reversed lottery/roulette type game that employs actions of players as the basis for determining the payout condition, according to an illustrative embodiment. The game allows for the selection by the player of multiple selectable tokens in which one selectable token loses, and the remaining multiple selectable tokens win. The wagering game system awards the player for each wager made by the player to a winning pot (i.e., any pot having the non-highest aggregated wager amount) during a pre-defined game session.

A game module 2002 receives a player submission 208 associated to a player action. The game module 2002 updates one of three or more global game counters maintained by the game module 2002 with the game token 210 generated therein, as described in relation to FIG. 9. At the conclusion of the game or betting round, the game module 2002 determines a selected game token having the highest total wager amount (shown as “t′1”) based on comparisons among the three or more global game counters. In the instance of a tie, following an update, the default global game counter is used as the selected game token“t′1”. The game module 2002 provides the selected game token information 2004 (i.e., the highest total wager token) to a payout module 2006.

The payout module 2006 determines if the game token (“a2”) 210 matches any game token having the non-highest total wager amount (“t′1”). That is, any selectable token that is not the selected game token determined in game module 2002. Upon a match, the payout module 2006 outputs a payout token 212.

In some embodiments, the payout module 2006 calculates the payout token 212 at the end of the game time period. Alternatively, the payout module 2006 calculates the payout token 212 following each instant that a player action is received. The payout associated with a payout token 212 may have up to a multiplier of “1.1” (i.e., the payout is 1:1.10). That is, for each $1 wager placed, the payout is $1.10. The payout rate may be dependent on the number of tokens available for selection by the players or may be varying according to the difference between the wager amount of the highest wager token and the remaining non-highest wager token. It should be appreciated that other payout rates may be applied, for example, between 10% and 100% of the submitted wager.

### Example #4: High Dimension Lottery and Roulette (e.g., the “Hi-Lo” Game)

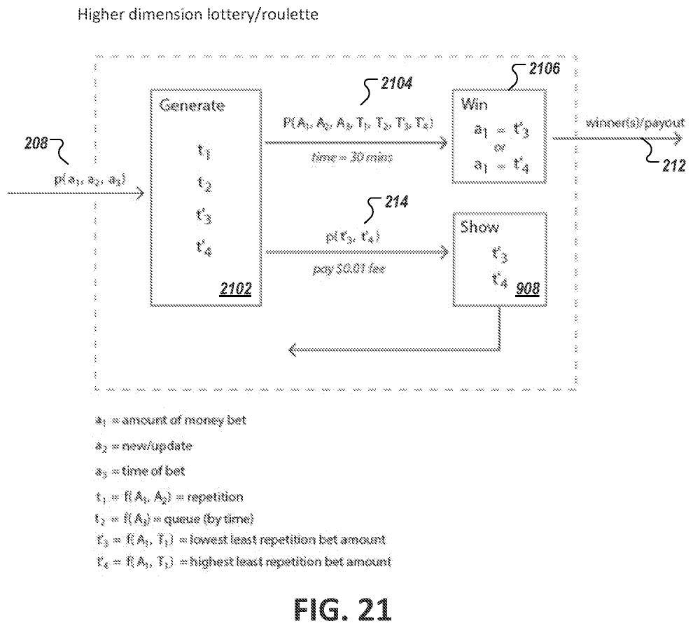

FIG. 21 shows a function diagram of a control module for a higher dimension lottery and roulette type game that employs actions of players as the basis for determining the payout condition, according to an illustrative embodiment. Specifically, the higher dimension lottery and roulette type game employs the wager amount of the players as the game piece (as opposed to, for example, a dice, cards, etc.). In some implementations, the wagering game system awards the player for each wager made to a lowest-wager least-repetition game token and/or a highest-wager least-repetition game token.

Put another way, while the game is active, the system allows a player to place any amount of wager into the main pot. The players can wager on a new hand, or update a previously submitted hand. The amount of wager in the main pot is presented to the player and is updated on a periodic basis (e.g., every one minute)—thereby ensuring that each individual player actions of the various players are not shown. The system determines, for each submitted new hand or updated hand, repetition token computed based on the repetition of player hands having the same amount of wager. Two winning tokens are computed by finding the lowest least repetition bet amount and the highest least repetition wager amount. In some instances, the highest-wager and lowest-wager least repetition game token is the same, e.g., where is only one token with the least frequency of repetition among the selectable game tokens.

A lowest-wager least-repetition game token refers to a selectable token having the lowest wager value among the tokens having the lowest repetition of selection by the players within the wagering game. That is, a wager to a lowest repetition token results in a payout, unless there are multiple tokens having that number of repetitions, then the lowest wager amount of that group receives a payout.

A highest-wager least-repetition game token refers to a selectable token having the highest wager value among the tokens having the lowest repetition of selection by the players within the games. The wager to a lowest repetition token results in a payout, unless there are multiple tokens having that number of repetitions, then the highest wager amount of that group receives a payout.

A game module 2102 receives a player submission 208 (shown as “p(a1, a2, a3)” 208) associated to a player action, including a wager amount a1 made by the player, a second wager amount a2 to a same selected token, and a time of bet a3. The game module 2102 determines the game token 210 as described in relation to FIG. 5. The game module 2102 updates one of multiple global game counters maintained by the game module 2102 with the game token 210. Indeed, each of the global game counter corresponds to a selectable token. In some embodiments, the game module 2102 determines on a periodic basis (e.g., every one minute during the game session) a selected game token having the lowest-wager least-repetition game (shown as “t′3”) and highest-wager least-repetition game (shown as “t′4”).

The game module 2102 provides the selected game token information (shown as “P(A1, A2, A3, T1, T2, T′3, T′4”) 2104) to a payout module 2106. The payout module 2106 determines if the game token (“a1” or “a2”) 210 matching the selected game token is the lowest-wager least-repetition token t′3 or the highest-wager least-repetition token t′4. Upon a match, the payout module 2106 outputs a payout token 212.

In some embodiments, the payout module 2106 calculates the payout token 212 at the end of the game time period. Alternatively, the payout module 2106 calculates the payout token 212 following each instant that a player action is received. The payouts associated with highest-wager least-repetition token t′4 and the lowest-wager least-repetition token t′3, in some embodiment are based on the size amount of wager placed by all the players (namely, the pot size). In some embodiments, the same payout is provided for each of the winning token (e.g. 49% of the pot for each of the token). In other embodiments, a different payout is provided for the winning tokens. For example, the payout for highest-wager least-repetition token t′4 may be 49% of the pot size, and the payout for lowest-wager least-repetition token t′3 may be 40% of the pot size.

Referring still to FIG. 21, the second computation module 908 computes any request for game information 214 that is received. A fee is transacted to a player account associated with the request. The fee may be a fixed-fee, for example, between $0.01 and the lowest wager amount (e.g., between $0.01 and $1). The response 216 to the request 214 includes the highest-wager least-repetition token t′4 and the lowest-wager least-repetition token t′3. In some embodiments, the player can elect either one of the winning condition.

In other implementations, rather than lowest or highest non-repetition game token, other payout conditions are employed (e.g., the top three highest non-repetition game token, the three lowest non-repetition game token, or any combinations thereof).

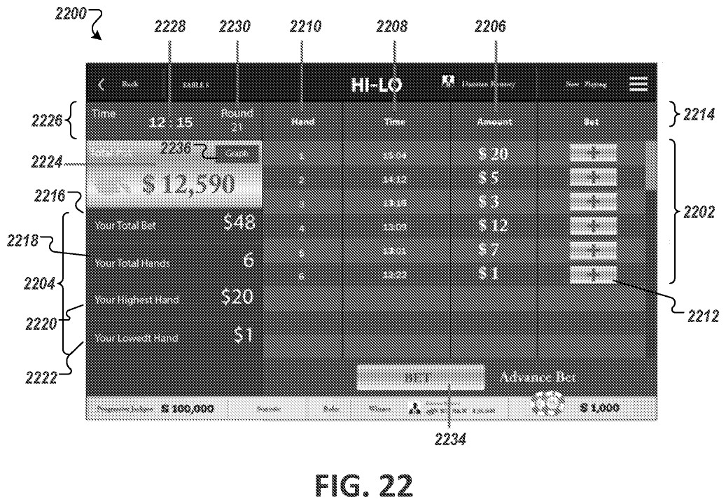

FIGS. 22 to 30 are screenshot of an exemplary higher dimension lottery or roulette type game, referred to as the “Hi-Lo” game, and as described in relation to FIG. 21. The game allows for the selection by the player of multiple selectable tokens and awards the player for each wager made by the player that meets the payout condition (i.e., the lowest and highest least-repetition wager). FIG. 22 illustrates a game dashboard 2200. The dashboard 2200 shows a wager workspace 2202 that lists each wager submitted by the player during the game session, including, for each wager, the wager amount 2206, the time in which the wager was placed 2208, the wager identifier 2210, and an input widget 2212 to update existing wagers with additional funds. The wager workspace 2202 may be arranged by a selection of the column header 2214. The summarized wager history 2204 includes the total wager placed by the player 2216, the total number of hands that the player has participated in the game 2218, the high token (i.e., wager) placed by the player 2220, and the lowest token (i.e., wager) placed by the player 2222.

As shown, the dashboard 2200 also presents the total pot size 2224 and game time information 2226. The game time information 2228 shows time remaining in the game session, the game round number 2230, and the round number 2232. The dashboard 2200 also provides a widget 2236 to illustrate a graph of wagering profile.

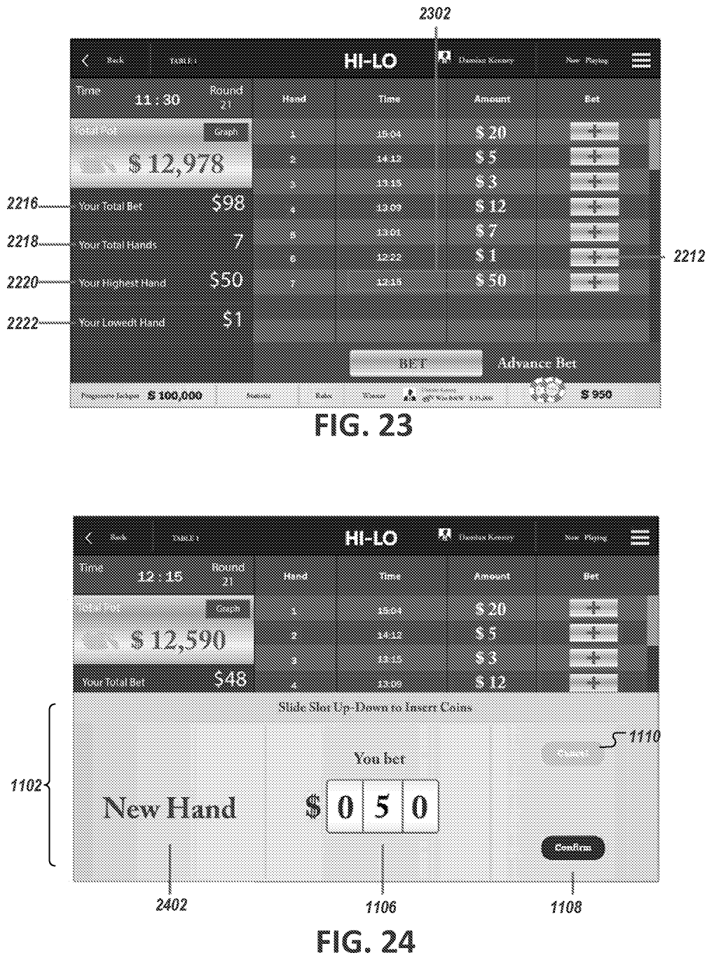

A new wager may be added via an input widget 2234. A new wager (as added via widget 2234) adds a new row to the number of hands of a player, as shown in FIG. 23. As shown in FIG. 23, the new hand for a wager of “$50” is shown as hand number “7” (2302). The new hand is added via a wager screen 1102, as shown in FIG. 24. The wager screen 1102 of FIG. 24 indicates a wager to a new token 2402, a wager widget 1106 to input a wager amount, a wager confirmation button 1108, and a wager cancel button 1110. After a new hand has been added, the wager workspace 2202 (2206, 2208, and 2210) and the summarized wager history (2216, 2218, 2220, and 2222) are updated.

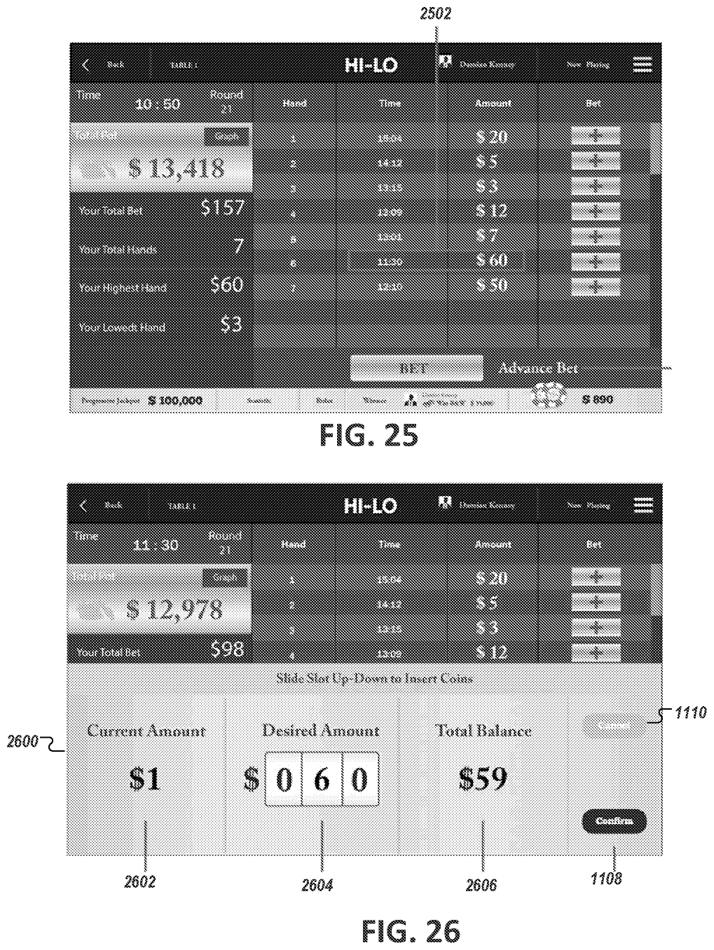

The update existing wager feature (corresponding to widget 2212 as shown in FIG. 22) allows a player to update a wager amount to an existing hand, thereby changing a selected token to a new token. The update existing wager feature, in some embodiments, allow the player to only add additional wager to an existing hand such that the player cannot decrement or remove the update once the update to the hand is completed. FIG. 25 illustrates an update to hand number “6” from a “$1” wager to a “$60” wager. The update requires an addition wager of $59 (2502). FIG. 26 illustrates an example update wager screen 2600. The screen 2600 presents the selected token to be updated (2602), the new wager amount (i.e., token) 2604, an indication of additional wager to be applied 2606, a wager confirmation button 1108, and a wager cancel button 1110.

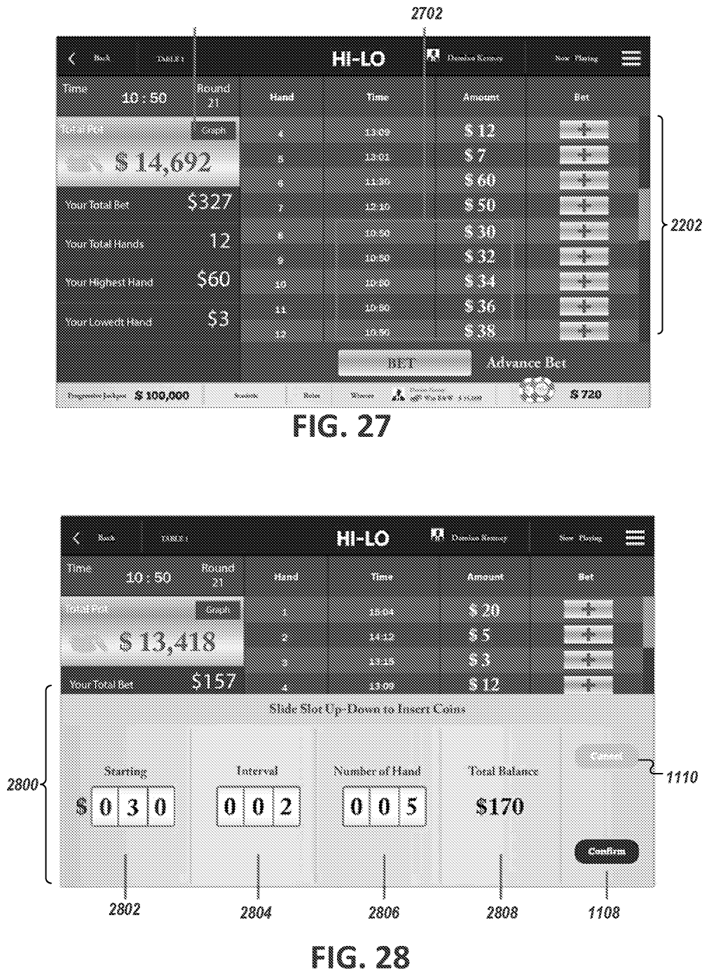

In some embodiment, the system allows a player to add multiple wagers in a single wager action. FIG. 28 illustrates an example advanced wager screen 2800 to add multiple wagers. The wager screen 2800 includes a widget 2802 to set a starting wager amount, a widget 2804 to add a number of hands, a widget 2806 to set a number of wager increment, an indication 2808 of the total wager to be placed from the action, a wager confirmation button 1108, and a wager cancel button 1110. As shown, the multiple wager screen is configured to add five additional hands, starting at a wager amount of “$30” that increments at an interval of “$2” per hand (that is “$30”, “$32”, “$34”, “$36”, and “$38”). The result wagers have a combined wager of “$170.” Upon confirmation of the wagers, the wager workspace 2202 is updated with the additional new hands 2702, as shown in FIG. 27.

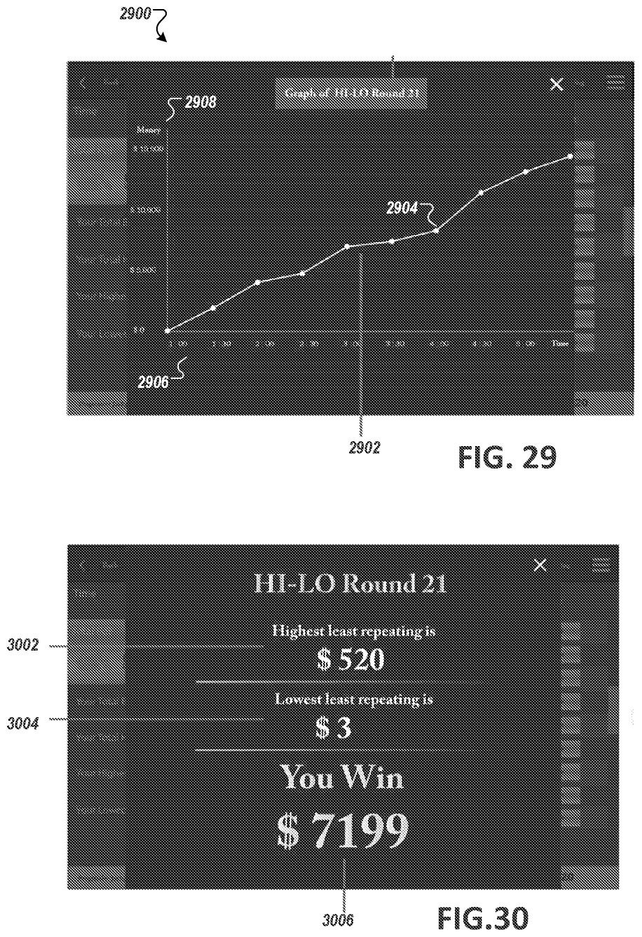

FIG. 29 illustrates an aggregated wagering information 2900 within the game session, accessed when the graph information 2236 (of FIG. 22) is pressed. The aggregated wagering information 2900 presents a profile 2902 of the pot size at each instance 2904 either an update to a player's hand or a new hand is added by the player. The x-axis 2906 shows the game time and the y-axis 2908 shows the pot size.

FIG. 30 shows a payout summary 1900, according to an embodiment. The summary 3000 indicates the winning tokens (3002, 3004) and the payout amount (3006). As shown, the player has the lowest wager least repetition token “$3” (3004) and is awarded 49% of the total pot ($14,692), which is shown as “$7,199” (3006).

Of course, the percentages and distributions of the pot size may vary according to the specifics of the game, which is made available to the players at the beginning of the game.

### Example #5: Simple Constant Payout Slot (e.g., the “Magic 9” Game)

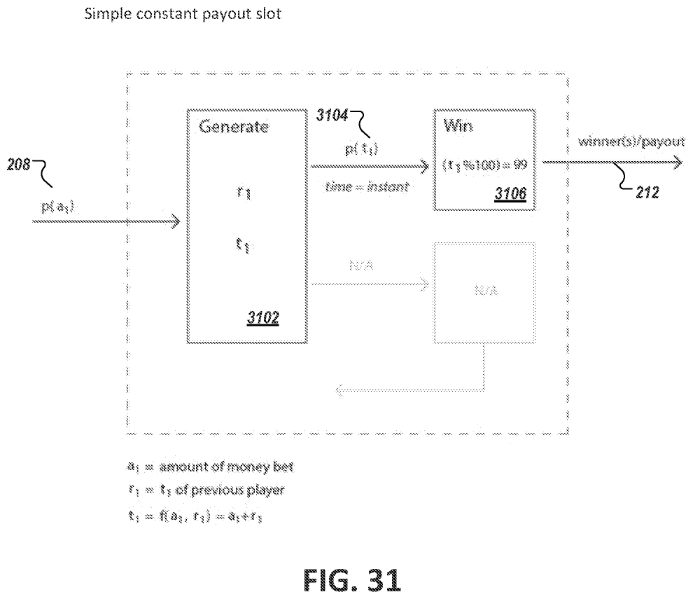

FIG. 31 shows a function diagram of a control module for a constant payout slot that employs actions of players as the basis for determining the payout condition, according to an illustrative embodiment. The wagering game system awards the player for each wager placed that causes an aggregated wager amount corresponding to a global game counter maintained by the system to meet or exceed a payout threshold amount.

A game module 3102 receives a player submission 208 (shown as “p(a1)” 208) associated to a player action, including a wager amount a1 made by the player. The game module 3102 determines the game token 210 as described in relation to FIG. 5. The game module 3102 updates a global game counter (e.g., corresponding to the wager amount) maintained by the game module 3102 with the game token 210. In some embodiments, the global game counter is an updated counter value “t1” following an update from a previous player submission.

The game module 3102 provides the updated game token information (shown as “p(t1)”) 3104) to a payout module 3106. The payout module 3106 determines if the updated global game counter is a winning counter value. In some embodiments, the payout module 3106 performs a modulus operand of “100” on the updated global game counter and then compares the resulting modulus output to a winning number. In other embodiments, the payout module 3106 first performs a modulus operand of the winning number on the updated global game counter and then compares the resulting modulus to the winning number.

The comparison may be to determine if the game token matches and/or exceeds a pre-defined winning number. Upon a match, the payout module 3106 outputs a payout token 212. In some implementations, the counter is reset to “0” upon a match.

In some embodiments, the payout module 3106 calculates the payout token 212 at the end of the game time period. Alternatively, the payout module 3106 calculates the payout token 212 following each instant that a player action is received. The payout may be a fixed value, for example, any value up to the winning number. For example, where the winning number is 99, the payout can be a fixed value up to $99. Of course, other payout values and ratios may be employed for a given payout.

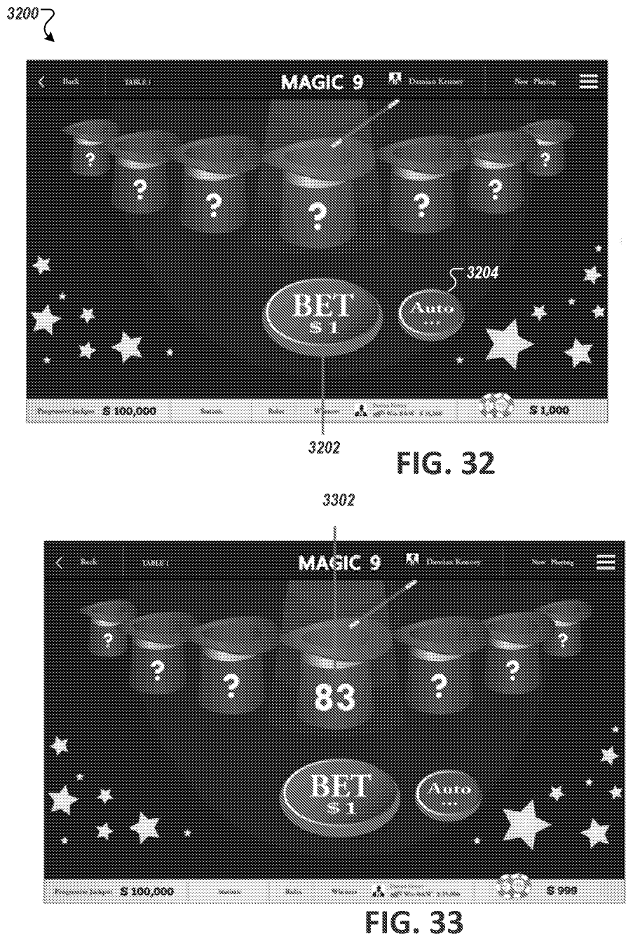

FIGS. 32 to 35 are screenshots of an exemplary constant payout slot type game, referred to as the “Magic 9” game, and as described in relation to FIG. 31. The game allows for the selection by the player of one or more selectable tokens (corresponding to a wager amount) and awards the player for each wager made by the player that causes the pot to reach a winning pot number.

FIG. 32 illustrates a game interface 3200 and shows a wager widget 3202 to allow a player to place a wager to the game. Upon a wager being placed, the interface indicates the current pot number 3302, which corresponds to the global counter number, as shown in FIG. 33. As shown, the widget 3202 corresponds to a “$1” wager. The game interface 3200 provides a widget 3204 to place multiple wagers via a single interface action.

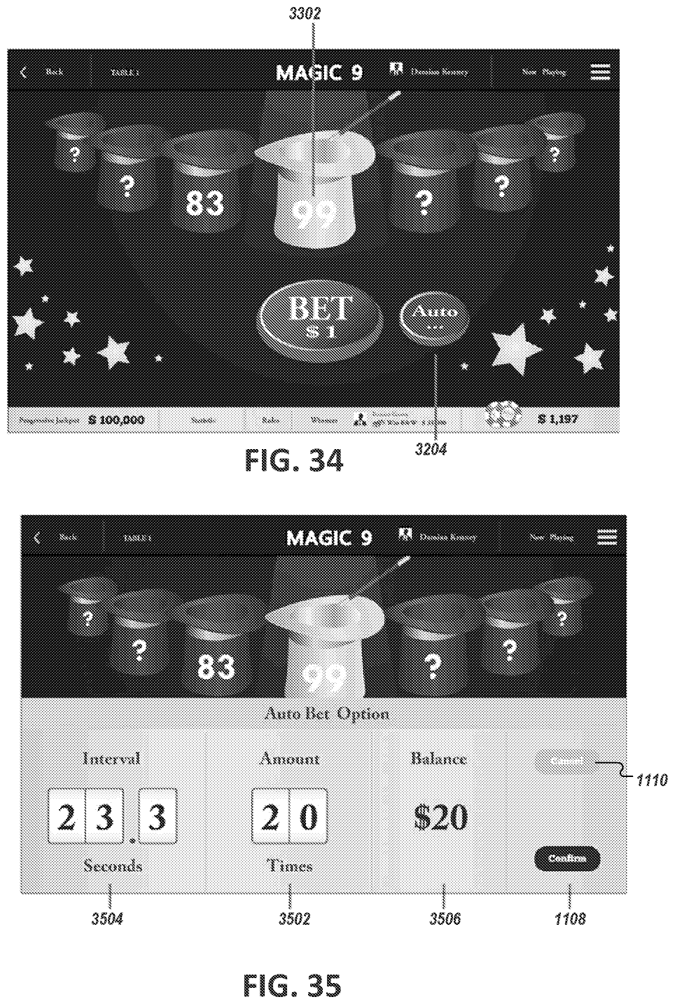

Upon the wager causing the current pot to match or exceed the winning number (for example, “99”), a payout condition occurs, as shown in FIG. 34. In some embodiments, following the payout condition, the global game counter is reset or initialized to an initial game value, for example, “$0.” Alternatively, the global counter may be implemented as a circular buffer. To this end, following a payout condition, the global game counter is reduced by the winning number.

The payout associated with the payout condition may be linked by the name. For example, a fixed-payout of “$99” may be distributed to the player for game counter of “99”. Of course, other numbers may be employed as the winning number.

The game may allow for multiple wagers to be placed via a single interface action, as shown in FIG. 35. The system may allow the player to specify the frequency to place a bet and the time period between each wager. The multiple wager interface 3502 may include a widget 3502 to specify the number of wagers, a widget 3504 to receive the period between each of the wagers, an indication 3506 of the total wager to be placed from the action, a wager confirmation button 1108, and a wager cancel button 1110.

### Example #6: Simple Constant Payout Slot (e.g., the “Devil 6” Game)

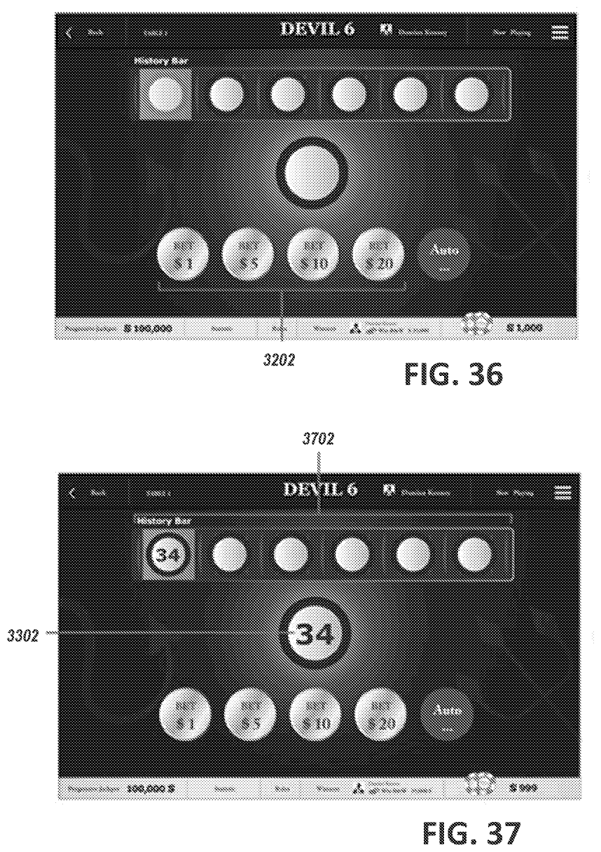

FIGS. 36 to 39 are screenshots of a second exemplary constant payout type game, referred to herein as the “Devil 6” game. The “Devil 6” game allows players to place varying wager amount (as opposed to a fixed incremental wager, as discussed in other examples). A payout condition is met when the total wager amount for the game meets and/or exceeds a winning number.

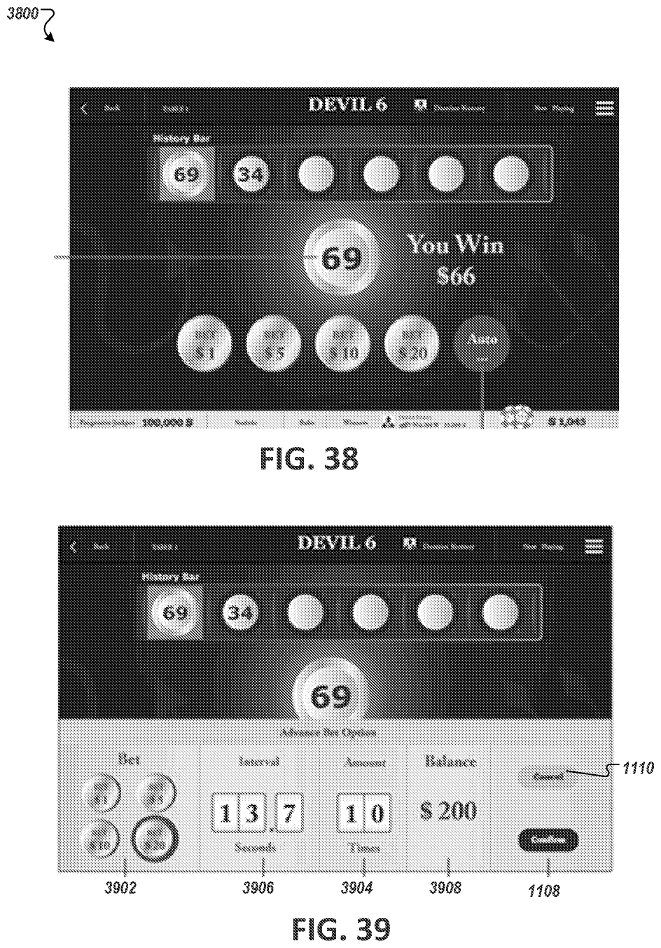

As shown in FIG. 36, the wager widget 3202 includes multiple selectable tokens corresponding to different wager values. As shown, the selectable tokens correspond to “$1”, “$5”, “$10”, and “$20” wagers. The system graphically presents the current counter value 3302 following each wager placed by the player. The system may show a wager history 3702 for the player, as shown in FIG. 37.

FIG. 38 shows a payout summary 3800, according to an embodiment. The payout summary 3800 may be shown only to the winning player. The summary 3800 may display an animation indicative of a winning condition being met. The payout for “Devil 6” may be a fixed payout value. In an example, the payout value is “$66”, which corresponds to the name of the “Devil 6” game. In some embodiments, additional wager exceeding the winning number is kept by the operator of the game.

The system may allow the player to place multiple wagers concurrently. As shown in FIG. 39, the system may receive a widget 3902 corresponding to a wager amount, a widget 3904 to specify the number of times to place the wager 3902, a widget 3906 to specify a time frequency in between each wager, an indication 3908 of the total wager, a confirmation button, a wager confirmation button 1108, and a wager cancel button 1110.

### Example #7: Higher Dimension Slot Game (e.g., the “Slot Machine 777” Game)

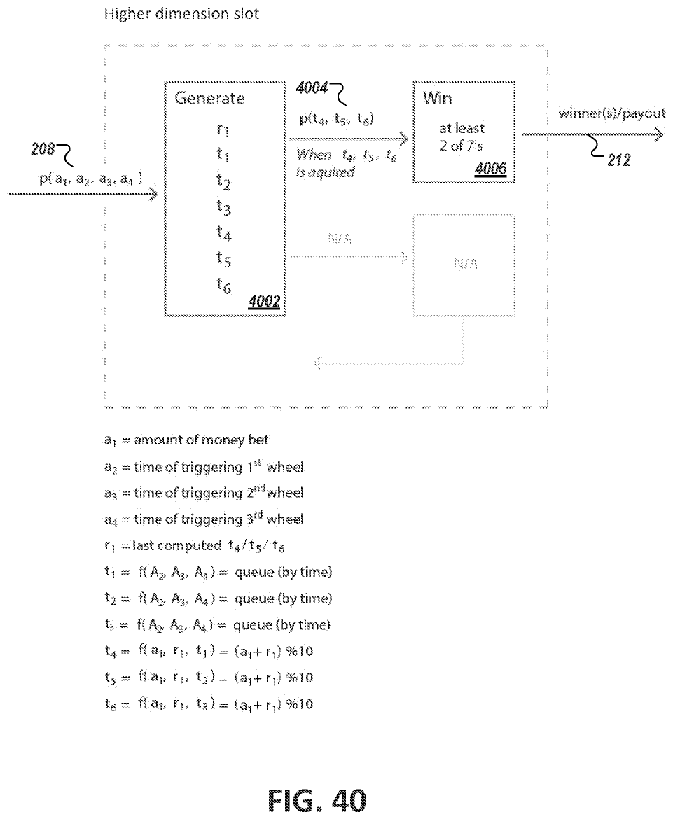

FIG. 40 shows a function diagram of a control module for a higher dimension slot game that employs actions of players as the basis for determining the payout condition, according to an illustrative embodiment. The wagering game system awards the player when a player action produces a pre-defined requisite number of payout game tokens within a set of potential payout game tokens. The potential payout game tokens correspond to each available resulting number of wheels of the slot machine and are generated based on a wager amount of the player and of historic set of payout game tokens generated from a previous player submission. In some embodiments, the wager amount is employed to arithmetically update a set of global game counters corresponding to the historic set of payout game tokens.

Put another way, the system allows a player to place any wager amount into a main pot. The player is given three opportunities to trigger one of a number of wheels (one chance per wheel). Once the player triggers a wheel, the last digit of a number will be given as a token. The number is a global number and it will be increased by the amount of money bet every time any player triggers any wheel.

A game module 4002 receives a player submission 208 (shown as “p(a1, a2, a3, a4)” 208) associated to a player action, including a wager amount a1 made by the player and a time associated with the triggering of each of the wheels (a2, a3, a4). The game module 2102 determines the game token 210 as described in relation to FIG. 5 for each of the actions.

The game module 2102 computes a value for each wheel, shown as “p(t4, t5, t6)” 4004 and provides the values 4004 to the payout module 4006. In some embodiments, the game module 2102 maintains a set of global game counters (t4, t5, and t6), in which the set corresponds to a last digit of game symbol employed in the slot wheel. The game module 2102 computes a value for each wheel by arithmetically updating each respective global game counter “r1” with the wager amount a1 following a trigger in any wheel (a2, a3, a4), as shown in Equation 4.

r1={t4,t5,t6} of another player game, where t4=(a1+r1t4) % no. of wheel symbols

t5=(a1+r1t5) % no. of wheel symbols

t6=(a1+r1t6) % no. of wheel symbols (Equation 4)

The payout module 4006 determines if a pre-defined requisite number of payout game tokens are within a set of potential payout game tokens. For example, the payout module 4006 may determine if there are at least two “7” symbol from the generated game tokens.

In some embodiments, payout module 4106 calculates the payout game tokens 212 based on the arrangements of a set of winning symbols forming a winning game pattern. In certain slot machines, nine symbols are shown for a three-wheel slot machine with each wheel showing three symbols. Examples of the winning game pattern includes, but not limited to, at least two of the winning game symbols “7” being arranged horizontally-across the center row, the top row, or the bottom row. Another example of the winning game patterns includes at least two of the winning game symbols “7” being arranged diagonally across the center symbol.

An example payout for having two of the winning symbol is a payout of 20% of the main pot, whereas a payout for three of the winning symbols results in a payout of 50% of the main pot.

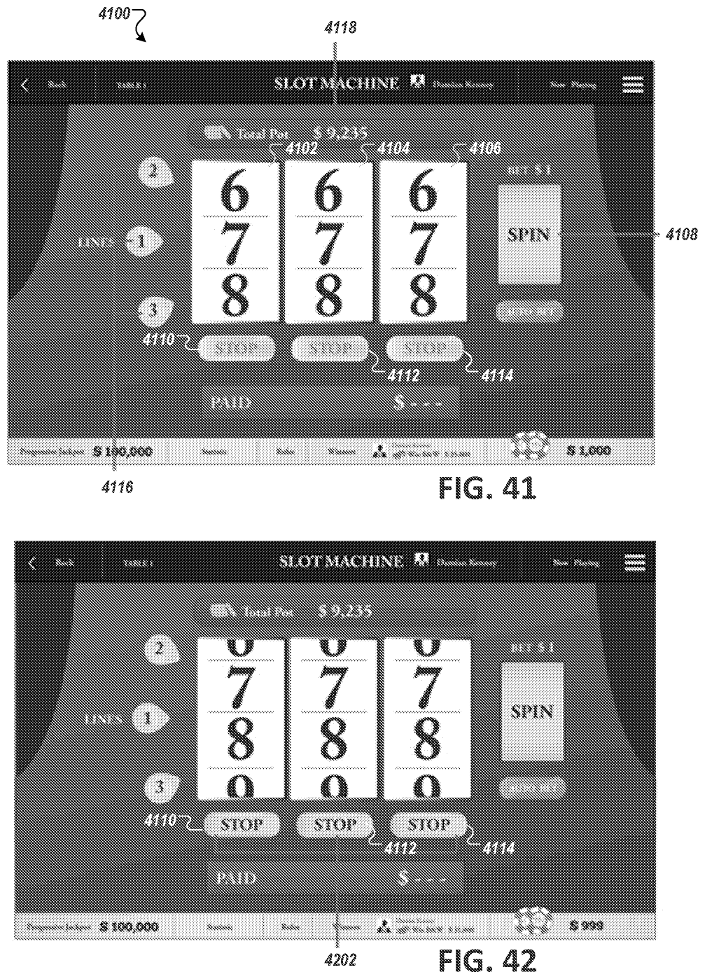

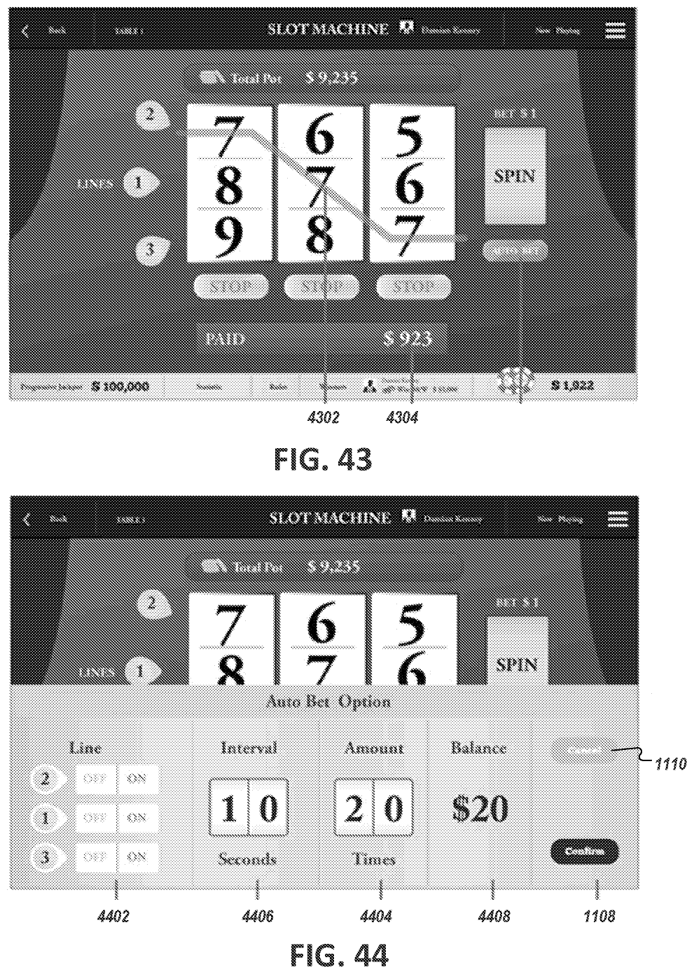

FIGS. 41 to 44 are screenshots of an exemplary higher dimension slot machine type game, and as described in relation to FIG. 40. FIG. 41 illustrates a graphical user interface 4100 having multiple vertical grids of symbols (shown as 4102, 4104, 4106) corresponding to a mechanical reel of a slot machine. More grids may be employed than three, for example, but not limited to, between three to eight vertical grids of symbols. The interface 4100 includes an input widget 4108 to initiate the game and to place a wager. Upon placement of the wager, the vertical grids of symbols 4102, 4104, 4106 are shown as rotating. The interface 4100 includes a game play widget (4110, 4112, 4114), which corresponds to each of the vertical grids (4102, 4104, 4106). The game play widget (4110, 4112, 4114) may be highlighted (shown as widget 4202) during the game session following a wager being placed, as shown in FIG. 42. The interface 4100 presents a set of selectable winning lines 4116 corresponding to a payout game pattern that the player can select. An example of the first winning diagonal line 4302 is shown in FIG. 43. In some embodiments, the system can receive multiple selections of the winning lines 4116. A payout indicator 4304 shows a payout amount when a payout condition is met (e.g., the game symbol matching the selected winning lines 4116 of the player). In some embodiments, the payout amount is based on a percentage of the main pot (shown via 4118), which corresponds to the total wagers placed from all the players.

FIG. 44 illustrates an automated wager screen 4400 to allow players to place multiple wagers via a single wager action. As shown, the wager screen 4400 includes a widget 4402 for selection of the winning line, an input 4404 for the wager amount, an input 4406 for the interval for each wager, an indicator 4408 of the cost of the action, a wager confirmation button 1108, and a wager cancel button 1110.

### Example #8: Sequence-Based Type Game (e.g., the “RGB” Game)

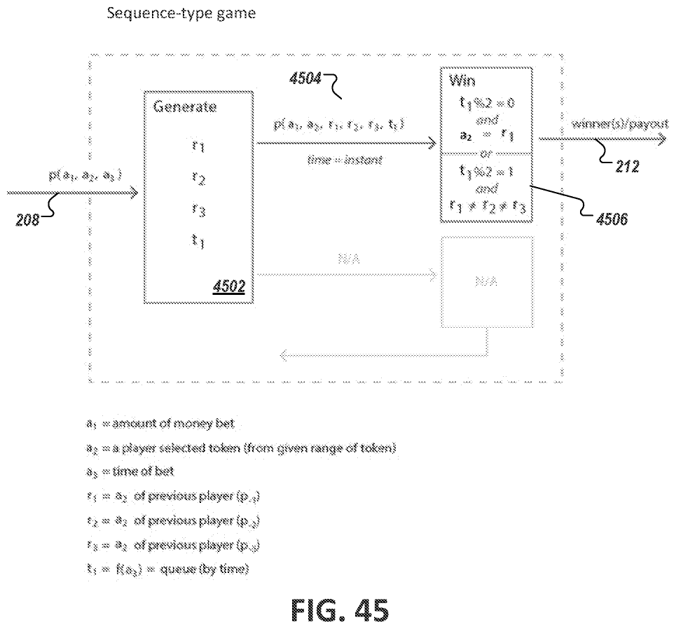

FIG. 45 shows a function diagram of a control module for a sequence-based type game that employs actions of players as the basis for determining the payout condition, according to an illustrative embodiment. The wagering game system awards the player when the player action produces a certain sequence of tokens in relation to tokens of others player. The tokens are arranged in an order that a token was selected by the various players.

For example, the “RGB” game allows each player to pick a selectable token having an associated color value (e.g., “red”, “green”, “blue”). The selection of the token is associated with a placement of a wager (e.g., “$1”) to a main pot. The game system calculates a queue token based on the rank of the wager in the queue placed by each of the respective player. Indeed, the queue token (e.g. a “0” or a “1”) is employed to determine the winning condition for the player. That is, the winning condition is different depending on the value of the queue token. For example, if the queue token is an “even” number (e.g., “0”), then the player would win if the token selected by another player preceding the player in the queue has the same associated color as that of the player. In turn, if the queue token corresponds to an “odd” number (e.g., “1”), then the player would win if the tokens selected by three players preceding the player in the queue have a different associated color among themselves.

As demonstrated, the game system employs the wager amount of the player as an input for the selection of the payout game rules. Consequently, the wager amount can be employed to change the condition of winning. An exemplary implementation is provided as follows: if the player submission equals wager amount x, then the winning calculation employs Rule A, else the winning calculation employs Rule B. For example, using the RGB game above, instead of a fixed wager (as discussed), the system allows the player to bet a different wager amount (e.g., “$2”). If the player bet “$1”, the payout condition discussed in the RGB game applies. However, if the player wagers “$2”, then the system may employ a third rule (e.g., if the queue token is even and differs from the previous player's token, then a payout of $4 results).

Referring still of FIG. 45, a game module 4502 receives a player submission 208 (shown as “p(a1, a2, a3)” 208) associated with a player action, including a wager amount a1 made by the player, a selectable token a2 having an associated symbol (e.g., a color), and a time a3 associated with the selection of the wager. The game module 4502 determines the game token 210 as described in relation to FIG. 5 for each of the actions and determines a sequence of token selection made by the respective players, shown as “p(a1, a2, r1, r2, r3, t1)” 4504.

The payout module 4506 receives the sequence information 4504 and determines (a) if the selected token a2 of the player matches a second game token identifier associated with a second player submission or (b) if the selected tokens of players preceding the player in the queue meet a certain condition (e.g., being different from among one another).

The payout amount and winning condition may be dependent on the location of the token within the sequence. For example, if a given player token is an “even” number, the game system may payout if a similar color token of another player precedes the given player token in the sequence. The payout for such a condition may be a multiplier of the wager placed (e.g., the multiplier may be 2 times the amount of the wager).

In another example, if the token is an “odd” number, the game system may payout if the three preceding tokens in the sequence all have a different color. The payout for such a condition may be determined based on a percentage of the main pot (e.g., 10% of the main pot).

In some embodiments, the system may provide the player with an option to risk the current payout for a bonus round with the opportunity for a greater payout. For example, if the player chooses to play the bonus round, if the player loses in the bonus round, the player would only receive a lower payout (e.g., $20 as opposed to 10% of the jackpot). However, if the player wins in the bonus round, the system awards the player with a greater payout (e.g., 50% of the jackpot).

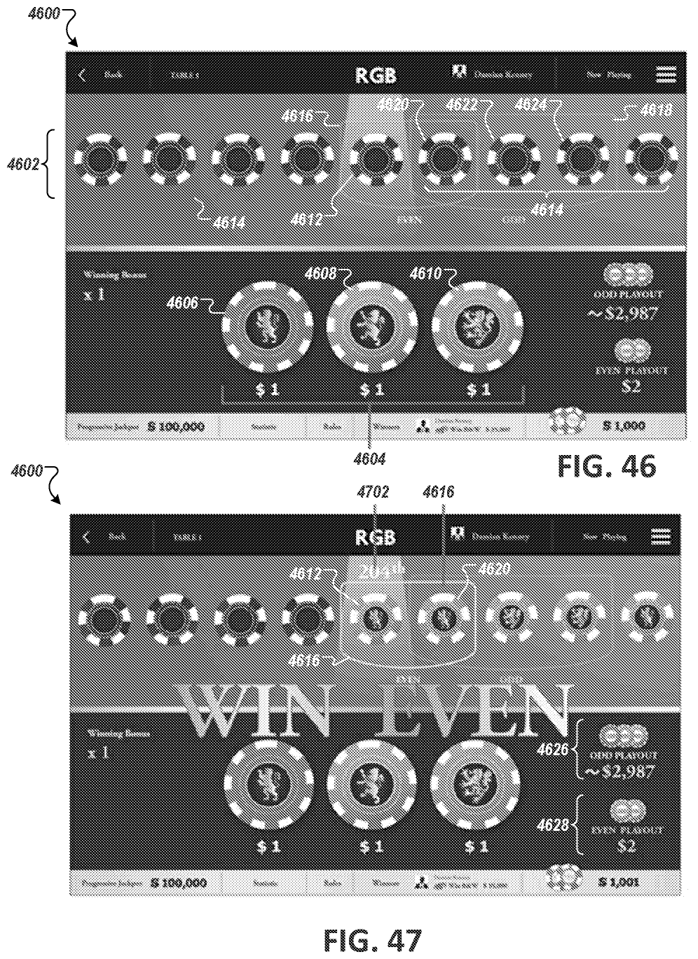

FIGS. 46 to 50 are screenshots of an exemplary sequence-based type game, referred to as “RGB”.

FIG. 46 illustrates a graphical user interface 4600 having a sequence of tokens 4602. The interface 4600 provides a widget 4604 for the player to make a selection of the token, here, shown as “red” 4606, “green” 4608, and “blue” 4610.

As players of the game select their respective tokens, the selected tokens are populated in the sequence 4602 according to a chronological order that the token selections are made. During the game session, the interface 4600 presents the selected token 4612 of the player in relation to tokens selected by the other players 4614.

As shown in FIG. 47, the interface 4600 indicates a numerical location of the token 4702 within the sequence (4602). The numerical location 4702 indicates whether the token 4612 is “odd” or “even” which is employed as the basis for the winning condition. As shown in FIG. 47, the interface 4600 also presents the potential payouts (4626, 4628) for the “even” payout condition and the “odd” payout condition.

The interface 4600 includes i) a game play box 4616 for an “even” number condition and ii) a game play box 4618 for an “odd” number condition. The “even” number winning condition includes both tokens (4612 and 4620) having the same color. That is, the token 4620 immediately preceding the token 4612 and the token 4612 must be of the same color.

The “odd” number winning condition includes the three preceding tokens 4620, 4622, and 4624 (shown in box 2614) having different color tokens. The three tokens of the players immediately preceding the token current player are shown as 4620, 4622, and 4624.

FIG. 47 illustrates an example winning condition for an “even” number token 4612. As shown, the preceding token 4620 in the game play box 4616 is “green” and matches the associated token color of the current player token 4612.

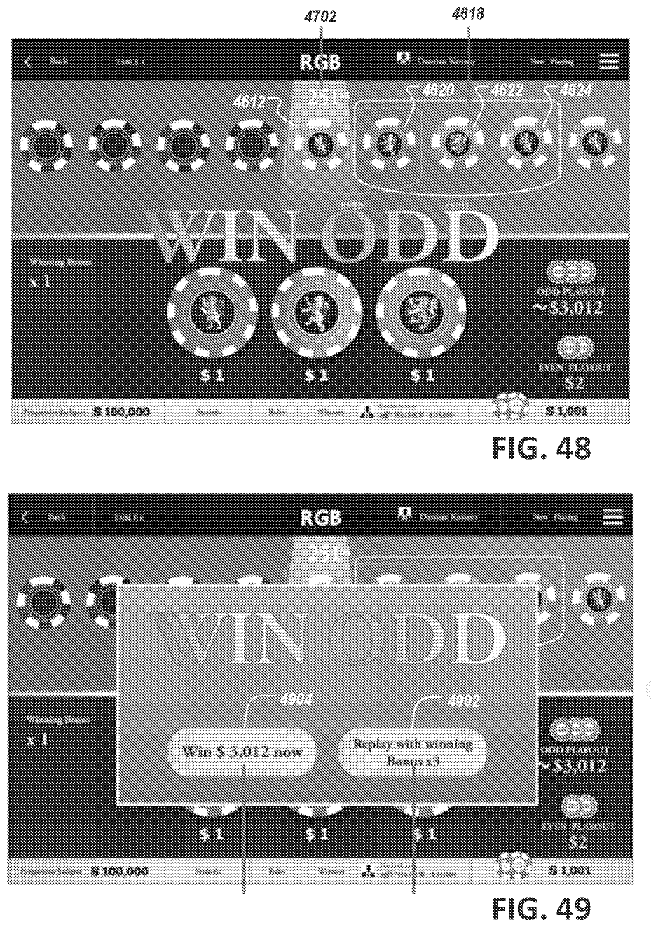

FIG. 48 illustrates an example winning condition for an “odd” number token 4612. As shown, the three preceding tokens 4620, 4622, and 4624 in the game play box 4618 include one of each respective color tokens (“red”, “green”, and “blue”).

FIG. 49 illustrates a bonus game play option. As indicated, the bonus option allows player the option 4902 to risk the current payout for a bonus round with the opportunity for a greater payout or to take the current payout 4904. Here, the bonus is three times the current payout amount.

### Example #9: Higher Dimension Game (e.g., the “Lotto Scratch” Game)

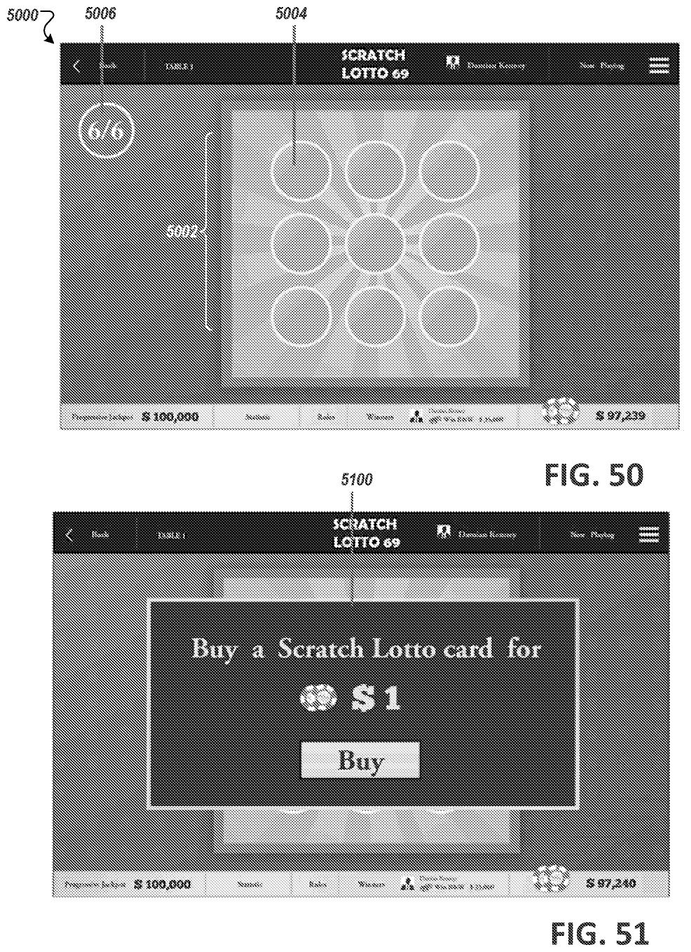

FIGS. 50 to 52 are screenshots of another higher-dimension game, referred to as “lotto scratch”. The “lotto scratch” game operates similar to the “Slot Machine 777” game in that the wagering system arithmetically updates a set of global game counters corresponding to the historic set of payout game tokens to produce a game card having multiple selectable game tokens. The player selects the hidden game tokens with the goal of matching symbols corresponding to the game tokens.

FIG. 50 illustrates a graphical user interface 5000 having multiple hidden game tokens 5002. Each game token 5004 is determined according to global game counters of completed games by other players preceding the instant game (e.g., the last completed game play). The interface 5000 indicates the available number of token 5006 that is selectable by the player.

FIG. 51 illustrates a wager screen 5100 to initiate a new game.

### Example #10: Social Gaming Platform

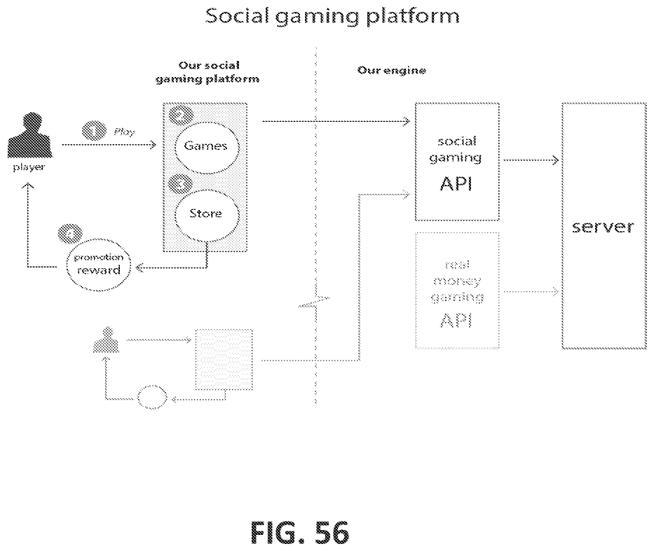

FIG. 56 illustrates a social gaming platform according to an exemplary embodiment. More specifically, the social gaming platform allows players to participate in the wagering games described above (e.g., lotto, hi-lo, slots, Magic 9, Devil 6, RGB) via a social gaming platform and/or architecture. Each player, using a corresponding player computing device (e.g., computer, mobile device, computing devices with web access) may connect to (e.g., via one or more networks) and/or interact with a social gaming platform, which in turn communicates with a social gaming application program interface (API). The social gaming platform may provide access to a variety of wagering games that can be played and/or participated in by each of the players. As shown in FIG. 56, multiple players (e.g., two players) are connected to the social gaming API via corresponding social gaming platforms.

In some example embodiments, the social gaming platform allows players to participate in wagering games without using and/or exchanging real-world money. That is, in some example embodiments, the “payouts” from winning in wagering games is not in the form of currency or payout tokens, but may instead be in the form of in-game money (e.g., credits). As shown in FIG. 56, in some example embodiments, a player may participate (e.g., play) in wagering games provided or made accessible by the social gaming platform. The players may play in the games without using real money or currency, but instead using credits, in-game money or the like provided by the social gaming platform (e.g., based on certain activity, upon initial joining or enrollment in the social gaming platform, etc.) or which may have been previously stored by the player in connection with the social gaming platform.

In turn, any credits or in-game money (e.g., not real world money) is used to trade or bid for rewards in a store (e.g., store infrastructure) or the like provided and/or made accessible by the social gaming platform. That is, each player can browse through the store and bid on or trade, using accumulated in-game money or credits, for rewards such as goods, services, coupons, awards or the like. In turn, winning bids and/or accepted trades are processed by the social gaming platform and/or store infrastructure, and the resulting rewards from those trades and/or bids are provided to the player and/or player computing device.

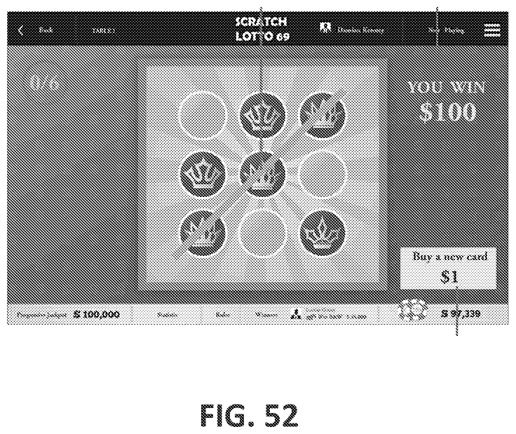

FIG. 52 illustrates an exemplary winning condition. As shown, the winning condition includes a same token symbol appearing in a straight line of three symbols. In some embodiments, the payout is based on a percentage of the wager amount in the game pot. The magnitude of the payout may be increased based on the number of straight lines that is generated. For example, a player may receive a 1× payout for a single straight winning line, a 3× payout for 2 straight winning lines, and a 10× payout for 3 straight winning lines.

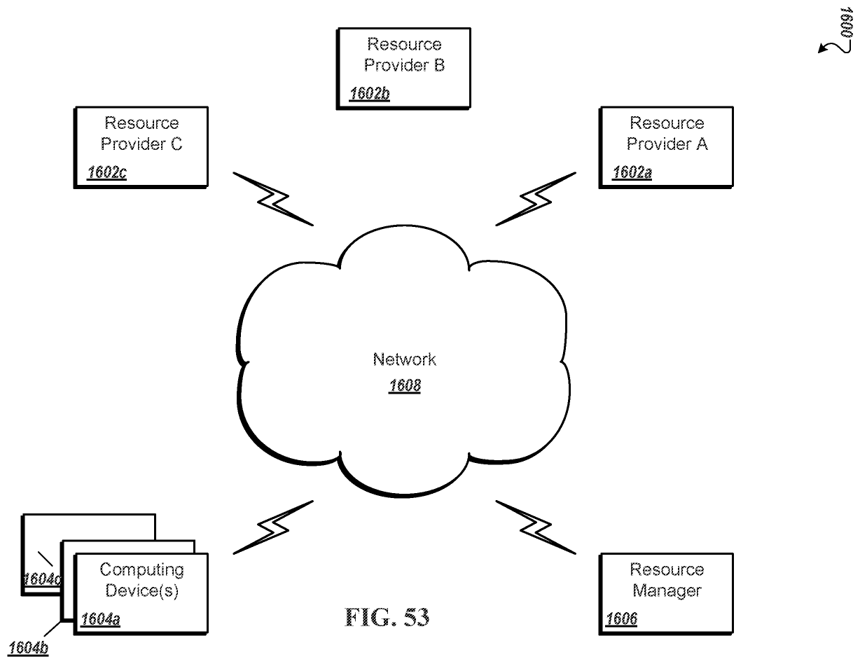

In brief overview, referring now to FIG. 53, a block diagram of an exemplary cloud computing environment 1600 is shown and described. The cloud computing environment 1600 may include one or more resource providers 1602a, 1602b, 1602c (collectively, 1602). Each resource provider 1602 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 1602 may be connected to any other resource provider 1602 in the cloud computing environment 1600. In some implementations, the resource providers 1602 may be connected over a computer network 1608. Each resource provider 1602 may be connected to one or more computing device 1604a, 1604b, 1604c (collectively, 1604), over the computer network 1608.

The cloud computing environment 1600 may include a resource manager 1606. The resource manager 1606 may be connected to the resource providers 1602 and the computing devices 1604 over the computer network 1608. In some implementations, the resource manager 1606 may facilitate the provision of computing resources by one or more resource providers 1602 to one or more computing devices 1604. The resource manager 406 may receive a request for a computing resource from a particular computing device 1604. The resource manager 1606 may identify one or more resource providers 1602 capable of providing the computing resource requested by the computing device 1604. The resource manager 1606 may select a resource provider 1602 to provide the computing resource. The resource manager 1606 may facilitate a connection between the resource provider 1602 and a particular computing device 1604. In some implementations, the resource manager 1606 may establish a connection between a particular resource provider 1602 and a particular computing device 1604. In some implementations, the resource manager 1606 may redirect a particular computing device 1604 to a particular resource provider 1602 with the requested computing resource.

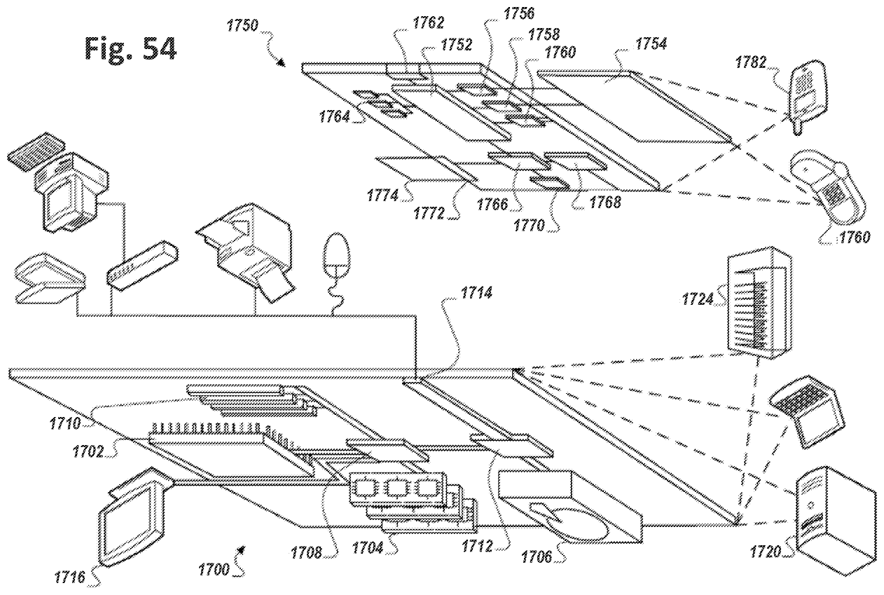

FIG. 54 shows an example of a computing device 1700 and a mobile computing device 1750 that can be used in the methods and systems described in this disclosure. The computing device 1700 is intended to represent various forms of digital computers, such as laptops, desktops, workstations, personal digital assistants, servers, blade servers, mainframes, and other appropriate computers. The mobile computing device 1750 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1700 includes a processor 1702, a memory 1704, a storage device 1706, a high-speed interface 1708 connecting to the memory 1704 and multiple high-speed expansion ports 1710, and a low-speed interface 1712 connecting to a low-speed expansion port 1714 and the storage device 1706. Each of the processor 1702, the memory 1704, the storage device 1706, the high-speed interface 1708, the high-speed expansion ports 1710, and the low-speed interface 1712, are interconnected using various busses, and may be mounted on a common motherboard or in other manners as appropriate. The processor 1702 can process instructions for execution within the computing device 1700, including instructions stored in the memory 1704 or on the storage device 1706 to display graphical information for a GUI on an external input/output device, such as a display 1716 coupled to the high-speed interface 1708. In other implementations, multiple processors and/or multiple buses may be used, as appropriate, along with multiple memories and types of memory.

Also, multiple computing devices may be connected, with each device providing portions of the necessary operations (e.g., as a server bank, a group of blade servers, or a multi-processor system).

The memory 1704 stores information within the computing device 1700. In some implementations, the memory 1704 is a volatile memory unit or units. In some implementations, the memory 1704 is a non-volatile memory unit or units. The memory 1704 may also be another form of computer-readable medium, such as a magnetic or optical disk.

The storage device 1706 is capable of providing mass storage for the computing device 1700. In some implementations, the storage device 1706 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1702), perform one or more methods, such as those described above. The instructions can also be stored by one or more storage devices such as computer- or machine-readable mediums (for example, the memory 1704, the storage device 1706, or memory on the processor 1702).

The high-speed interface 1708 manages bandwidth-intensive operations for the computing device 1700, while the low-speed interface 1712 manages lower bandwidth-intensive operations. Such allocation of functions is an example only. In some implementations, the high-speed interface 1708 is coupled to the memory 1704, the display 1716 (e.g., through a graphics processor or accelerator), and to the high-speed expansion ports 1710, which may accept various expansion cards (not shown). In the implementation, the low-speed interface 1712 is coupled to the storage device 1706 and the low-speed expansion port 1714. The low-speed expansion port 1714, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 1700 may be implemented in a number of different forms, as shown in the figure. For example, it may be implemented as a standard server 1720, or multiple times in a group of such servers. In addition, it may be implemented in a personal computer such as a laptop computer 1722. It may also be implemented as part of a rack server system 1724. Alternatively, components from the computing device 1700 may be combined with other components in a mobile device (not shown), such as a mobile computing device 1750. Each of such devices may contain one or more of the computing device 1700 and the mobile computing device 1750, and an entire system may be made up of multiple computing devices communicating with each other.

The mobile computing device 1750 includes a processor 1752, a memory 1764, an input/output device such as a display 1754, a communication interface 1766, and a transceiver 1768, among other components. The mobile computing device 1750 may also be provided with a storage device, such as a micro-drive or other device, to provide additional storage. Each of the processor 1752, the memory 1764, the display 1754, the communication interface 1766, and the transceiver 1768, are interconnected using various buses, and several of the components may be mounted on a common motherboard or in other manners as appropriate.

The processor 1752 can execute instructions within the mobile computing device 1750, including instructions stored in the memory 1764. The processor 1752 may be implemented as a chipset of chips that include separate and multiple analog and digital processors. The processor 1752 may provide, for example, for coordination of the other components of the mobile computing device 1750, such as control of user interfaces, applications run by the mobile computing device 1750, and wireless communication by the mobile computing device 1750.

The processor 1752 may communicate with a user through a control interface 1758 and a display interface 1756 coupled to the display 1754. The display 1754 may be, for example, a TFT (Thin-Film-Transistor Liquid Crystal Display) display or an OLED (Organic Light Emitting Diode) display, or other appropriate display technology. The display interface 1756 may comprise appropriate circuitry for driving the display 1754 to present graphical and other information to a user. The control interface 1758 may receive commands from a user and convert them for submission to the processor 1752. In addition, an external interface 1762 may provide communication with the processor 1752, so as to enable near area communication of the mobile computing device 1750 with other devices. The external interface 1762 may provide, for example, for wired communication in some implementations, or for wireless communication in other implementations, and multiple interfaces may also be used.

The memory 1764 stores information within the mobile computing device 1750. The memory 1764 can be implemented as one or more of a computer-readable medium or media, a volatile memory unit or units, or a non-volatile memory unit or units. An expansion memory 1774 may also be provided and connected to the mobile computing device 1750 through an expansion interface 1772, which may include, for example, a SIMM (Single In Line Memory Module) or DIMM (Dual In Line Memory Module) card interface. The expansion memory 1774 may provide extra storage space for the mobile computing device 1750, or may also store applications or other information for the mobile computing device 1750. Specifically, the expansion memory 1774 may include instructions to carry out or supplement the processes described above, and may include secure information also. Thus, for example, the expansion memory 1774 may be provided as a security module for the mobile computing device 1750, and may be programmed with instructions that permit secure use of the mobile computing device 1750. In addition, secure applications may be provided via the SIMM/DIMM cards, along with additional information, such as placing identifying information on the SIMM/DIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 1752), perform one or more methods, such as those described above. The instructions can also be stored by one or more storage devices, such as one or more computer- or machine-readable mediums (for example, the memory 1764, the expansion memory 1774, or memory on the processor 1752). In some implementations, the instructions can be received in a propagated signal, for example, over the transceiver 1768 or the external interface 1762.

The mobile computing device 1750 may communicate wirelessly through the communication interface 1766, which may include digital signal processing circuitry where necessary. The communication interface 1766 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1768 using a radio-frequency. In addition, short-range communication may occur, such as using a Bluetooth®, Wi-Fi™, or other such transceiver (not shown). In addition, a GPS (Global Positioning System) receiver module 1770 may provide additional navigation- and location-related wireless data to the mobile computing device 1750, which may be used as appropriate by applications running on the mobile computing device 1750.

The mobile computing device 1750 may also communicate audibly using an audio codec 1760, which may receive spoken information from a user and convert it to usable digital information. The audio codec 1760 may likewise generate audible sound for a user, such as through a speaker, e.g., in a handset of the mobile computing device 1750. Such sound may include sound from voice telephone calls, may include recorded sound (e.g., voice messages, music files, etc.) and may also include sound generated by applications operating on the mobile computing device 1750.

The mobile computing device 1750 may be implemented in a number of different forms, as shown in the figure. For example, it may be implemented as a cellular telephone 1780. It may also be implemented as part of a smart-phone 1782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While the invention has been particularly shown and described with reference to specific preferred embodiments, it should be understood by those skilled in the art that various changes in form and detail may be made therein without departing from the spirit and scope of the invention as defined by the appended claims.

Throughout the description, where apparatus and systems are described as having, including, or comprising specific components, or where processes and methods are described as having, including, or comprising specific steps, it is contemplated that, additionally, there are apparatus, and systems of the present invention that consist essentially of, or consist of, the recited components, and that there are processes and methods according to the present invention that consist essentially of, or consist of, the recited processing steps.

1. A method for operating a wagering game system, the method comprising:
receiving over a network, by one or more processors of one or more first computing devices, from a plurality of wagering game clients, a plurality of player submissions,
wherein each player submission of the plurality of player submissions corresponds to a given player action received at a given wagering game client and comprises data corresponding to one or more of a placed wager, a selected wager option, and a wager amount of the given player action,
wherein, collectively, the plurality of player submissions is employed as a basis to determine a payout outcome for players participating in a multiple player wagering game of the wagering game system, whereby the individual player actions of the players within the wagering game are hidden and/or delayed in presentation to the players;
determining, by the one or more processors, if a given player submission specific to a first player matches a payout condition of the wagering game, wherein the payout condition is based, at least, on a plurality of player submissions antedating the given player submission;
assigning, by the one or more processors, a game token associated with a payout to the first player upon a determination that the given player submission matches the payout condition;
causing, by the one of more processors, based on the assigned game token, a payout indicator to be graphically displayed at a wagering game client associated with the first player; and
recording, by the one or more processors, game results of the multiple player wagering game in a data storage location such that the game results are accessible for auditing, the game results comprising the plurality of player submissions antedating the given player submission, the payout outcome, the given player submission, and the payout condition.

2. The method of claim 1, wherein the step of determining if the given player submission specific to the first player matches the payout condition comprises:
determining if the given player submission is associated with a corresponding game token determined to have a lowest aggregated wagering amount from among an aggregated wagering amount of each of two or more game tokens available for selection by the player,
wherein the aggregated wager amount for each game token is arithmetically determined based on the given player submission and a plurality of player submissions (a) associated with the game token and (b) antedating the given player submission.

3. The method of claim 1, wherein the step of determining if the given player submission specific to the first player matches the payout condition comprises:
determining if the given player submission specific to the first player is associated with a corresponding game token determined to have a non-highest aggregated wagering amount from among an aggregated wagering amount of each of two or more game tokens available for selection by the player;
wherein the aggregated wager amount for each game token is arithmetically determined based on the plurality of player submissions (a) associated with the game token and (b) antedating the given player submission.

4. The method of claim 1, wherein the step of determining if the given player submission specific to the first player matches the payout condition comprises:
determining if the given player submission is associated with a corresponding game token determined to be a lowest-wager least-repetition game token determined to have a lowest- wager and least-repetition of selection associated with player submissions from among two or more selectable game tokens available for selection by the first player,
wherein the lowest-wager least-repetition game token is determined based on the given player submission and the plurality of player submissions (a) associated with the game token and (b) antedating the given player submission.

5. The method of claim 1, wherein the step of determining if the given player submission specific to the first player matches the payout condition comprises:
determining if the given player submission is associated with a corresponding game token determined to be a highest wager least-repetition game token determined to have a highest-wager and least-repetition of selection associated with player submissions antedating the given player submission from among two or more selectable game tokens available for selection by the first player,
wherein the highest-wager least-repetition game token is determined based on the given player submission and the plurality of player submissions (a) associated with the game token and (b) antedating the given player submission.

6. The method of claim 1, wherein the step of determining if the given player submission specific to the first player matches the payout condition comprises:
determining if the given player submission is associated with a wager amount that causes an aggregated wager amount to meet or exceed a payout threshold amount,
wherein the aggregated wager amount is arithmetically determined from (i) the wager amount associated with the given player submission and (ii) wager amounts associated with a portion of the plurality of player submissions antedating the given player submission.

7. The method of claim 1, wherein the step of determining if the given player submission specific to the first player matches the payout condition comprises:
determining if the given player submission produces a pre-defined requisite number of payout game tokens within a set of payout game tokens,
wherein each payout game token of the set of payout game tokens is arithmetically generated, at least, from:
(i) a wager amount associated with the current player submission, and
(ii) historic set of payout game tokens generated from a second player submission associated a second player different from the first player.

8. (canceled)

9. The method of claim 1, wherein the step of determining if the given player submission specific to the first player matches the payout condition comprises:
determining if the given player submission specific to the first player comprises a first game token identifier matching a second game token identifier associated with a second player submission submitted by a second player, wherein the first player submission and the second player submission are defined in respective locations within a queue of the plurality of player submissions, corresponding to the sequence of player submission.

10. The method of claim 1, wherein each player submission of the plurality of player submissions are combined with a clock pulse associated with the first computing device to generate an index value, wherein the index value is employed to select a token from an array of token associated with an index value.

11. (canceled)

12. The method of claim 1, comprising:
causing, by the processor, near real-time graphical presentation of an aggregated wager amount to the wagering game client associated with the first player following receipt of the given player submission specific to the first player.

13. The method of claim 1, comprising:
responsive to the determination of the matched payout condition, causing, by the processor of the first computing device, an electronic payout to be transferred to a player account associated with the first player or a payout pot to be dispensed at the wagering game client associated with the first player.

14. (canceled)

15. The method of claim 1, wherein the first wagering game client associated with the first player comprises a slot machine, a video gaming machine, or a computing device associated with the first player.

16. (canceled)

17. The method of claim 1, wherein the given player submission specific to the first player is synchronized to a clock pulse associated with the first computing device.

18. The method of claim 1 wherein the payout indicator is graphically displayed at the wagering game client either:
(i) following a pre-defined time window; or
(ii) following a conclusion of the wagering game.

19. The method of claim 1, comprising:
causing, by the one of more processors, following a conclusion of the wagering game, the plurality of player submissions to be graphically presented at a portion of the plurality of wagering game clients.

20-21. (canceled)

22. A method for operating a wagering game system, the method comprising:
receiving over a network, by a processor of a first computing device, from a first wagering game client, a first player submission, wherein the first player submission corresponds to an input from a user interface of the first wagering game client, wherein the first player submission comprises data corresponding to one or more of a placed wager, a selected wager option, and a wager amount selected with the input, and wherein the first wagering game client is a member of a plurality of wagering game clients in the wagering game system;
accessing, by the processor of the first computing device, game data of the wagering game, wherein the game data (i) is employed as a basis to determine a payout and/or winning outcome of the wagering game whereby no random or pseudorandom number is employed and (ii) is updatable based upon player submissions received from the plurality of wagering game clients;
updating, by the processor of the first computing device, the accessible game data based upon the first player submission;
responsive to a determination, by the processor of the first computing device, of the accessible game data updated based on the first player submission matching a payout condition for the wagering game, causing a payout outcome for the wagering game to be graphically displayed at the first wagering game client, wherein the payout condition is based, at least, on a plurality of player submissions antedating the given player submission; and
recording, by the one or more processors, game results of the multiple player wagering game in a data storage location such that the game results are accessible for auditing, the game results comprising the plurality of player submissions antedating the given player submission, the first player submission, the payout outcome, and the payout condition.

23. The method of claim 22, wherein the payout and/or winning outcome of the wagering game is determined based on cumulative actions received from all players of the wagering game,
wherein each action of the cumulative actions is either delayed in being presented to other players or not presented to the other players.

24-71. (canceled)
